(19) United States
(12) Patent Application Publication
(10) Pub. No.: US 2012/0106477 A1
(43) Pub. Date: May 3, 2012

(54) APPARATUS AND METHOD OF TRANSMITTING POWER INFORMATION REGARDING COMPONENT CARRIER IN MULTI-COMPONENT CARRIER SYSTEM

(75) Inventors: Ki Bum KWON, Ansan-si (KR); Jae Hyun AHN, Seongnam-si (KR)

(73) Assignee: PANTECH CO., LTD., Seoul (KR)

(21) Appl. No.: 13/286,575

(22) Filed: Nov. 1, 2011

(30) Foreign Application Priority Data
Nov. 3, 2010 (KR) 10-2010-0108833
Nov. 5, 2010 (KR) 10-2010-0110001

(51) Int. Cl. H04W 52/00; H04W 72/04

(52) U.S. Cl. 370/329; 370/328

(57) ABSTRACT

An apparatus and method for transmitting maximum transmit power information in a multi-component carrier system. A method for transmitting power information regarding a component carrier includes: calculating power headroom which can be additionally output from an activated uplink component carrier; calculating maximum transmit power configured for the activated uplink component carrier; generating a medium access control (MAC) message including a first field indicating the power headroom and a second field indicating the maximum transmit power; and transmitting the MAC message to a base station (BS). The BS can know about maximum transmit power of each uplink component carrier, preventing excessive uplink scheduling to thus reduce interference. Also, the BS can clearly know about to which uplink component carrier maximum transmit power is related.

This application claims priority from and the benefit under 35 U.S.C. §119(a) of Korean Patent Application No. 10-2010-0108833, filed on Nov. 3, 2010, and Korean Patent Application No. 10-2010-0110001, filed on Nov. 5, 2010, the disclosures of which are incorporated herein by reference for all purposes.

### BACKGROUND

1. Field

The present invention relates to wireless communication and, more particularly, to an apparatus and method for transmitting power information regarding a component carrier in a multi-component carrier system.

2. Discussion of the Background

A stereoscopic video service provides a stereoscopic image to a viewer through video images of left and right views. Since a stereoscopic image is provided to the viewer through images of left and right views, a larger amount of data should be transmitted in the stereoscopic video service in comparison to a monoscopic video service.

Candidates of the next-generation wireless communication system, such as 3rd Generation Partnership Project (3GPP) Long Term Evolution (LTE) and Institute of Electrical and Electronics Engineers (IEEE) 802.16m are being developed. The IEEE 802.16m standard involves two aspects, a change to the existing IEEE 802.16e standard and a standard for the next-generation IMT-Advanced system. Accordingly, the IEEE 802.16m standard fulfills all advanced requirements for the IMT-Advanced system while maintaining compatibility with a Mobile WiMAX system based on the IEEE 802.16e standard.

A wireless communication system uses bandwidth for data transmission. For example, the 2nd generation wireless communication system uses a bandwidth of 200 KHz to 1.25 MHz, and the 3rd generation wireless communication system uses a bandwidth of 5 MHz to 10 MHz. In order to support an increasing transmission capacity, the bandwidth of the recent 3GPP LTE or 802.16m is extended up to 20 MHz or higher. Increasing the bandwidth may be done in conjunction with the increase of transmission capacity to support a greater bandwidth; however, this may generate a large power consumption even though the required level of Quality of Service (QoS) is low.

Accordingly, a multi-component carrier system has been developed in which a component carrier having a bandwidth and the center frequency is defined, and data is transmitted or received in a wide band through a plurality of component carriers. That is, a narrow band and a wide band are supported at the same time by using one or more component carriers. For example, if one component carrier corresponds to a bandwidth of 5 MHz, a maximum of 20 MHz bandwidth can be supported by using four component carriers.

A method for a base station to efficiently utilize the resources of a mobile station has also been developed by using power information about the mobile station. A power control technique is a technique for minimizing interference factors and for reducing the battery consumption of a mobile station in order to efficiently distribute resources in a wireless communication. A mobile station may determine uplink transmit power based on Transmit Power Control (TPC) allocated by a base station, a Modulation and Coding Scheme (MCS), and scheduling information about the bandwidth, etc.

As a multiple component carrier system is introduced, the uplink transmit power of component carriers is generally taken into consideration. Accordingly, the power control of a mobile station becomes more complicated. Such complexity may cause problems in terms of a maximum transmit power of a mobile station. In general, a mobile station is operated by power lower than a maximum transmit power that is allowed. If a base station performs scheduling requiring a transmit power higher than the maximum transmit power, a problem may be caused in which an actual uplink transmit power exceeds the maximum transmit power. This is because power control for multiple component carriers has not been clearly defined or information about an uplink transmit power has not been sufficiently shared between a mobile station and a base station. Accordingly, a method of transmitting information on uplink transmit power is necessary.

### SUMMARY

It is, therefore, an aspect of the present invention provides an apparatus and method for transmitting power information regarding a component carrier in a multi-component carrier system.

Another aspect of the present invention provides an apparatus and method for receiving power information regarding a component carrier in a multi-component carrier system.

Another aspect of the present invention provides an apparatus and method for triggering a power report regarding a component carrier in a multi-component carrier system.

Another aspect of the present invention provides an apparatus and method for indexing the range of maximum transmit power regarding a component carrier by stage in a multi-component carrier system.

Another aspect of the present invention provides an apparatus and method for updating a reference table regarding maximum transmit power regarding a component carrier by stage in a multi-component carrier system.

Another aspect of the present invention provides an apparatus and method for configuring power information regarding a component carrier by stage in a multi-component carrier system.

Another aspect of the present invention provides an apparatus and method for configuring a MAC control element including power information regarding a component carrier by stage in a multi-component carrier system.

According to an aspect of the present invention, there is provided a method for transmitting power information regarding a component carrier by a user equipment (UE) in a multi-component carrier system. The transmission method may include: calculating power headroom which can be additionally output with respect to an uplink component carrier, calculating maximum transmit power configured for the uplink component carrier, generating a medium access control (MAC) message including a first field indicating the power headroom and a second field indicating the maximum transmit power, and transmitting the MAC message to a base station (BS).

The MAC message may include a MAC subheader and a MAC control element, the MAC subheader includes a logical channel identifier (LCID) indicating that the MAC control element includes both the first and second fields, the MAC control element includes first and second octets each having an 8-bit length, and the first octet includes the first field and the second octet includes the second field.

According to another aspect of the present invention, there is provided a method for receiving power information regarding a component carrier by a base station in a multi-component carrier system. The reception method may include: transmitting an uplink grant indicating uplink resource required for an uplink transmission to a user equipment (UE), and receiving a medium access control (MAC) message from the UE through the uplink resource.

The MAC message may include a MAC control element and a MAC subheader, the MAC control element includes a first field, a second field, a first octet and a second octet, the MAC subheader includes a logical channel identifier (LCID) indicating that the MAC control element includes both the first and second fields.

The first field may indicate power headroom which can be additionally output with regards to an activated uplink component carrier configured in the UE, the second field may indicate maximum transmit power configured for the activated uplink component carrier, each of the first and second octets has an 8-bit length, the first octet includes the first field and the second octet includes the second field.

According to another aspect of the present invention, there is provided a user equipment (UE) for transmitting power information regarding a component carrier in a multi-component carrier system. The UE may include: a downlink information transmission unit for receiving an uplink grant for a transmission of new uplink data from a base station (BS), a power calculation unit for calculating power headroom which can be additionally output by the UE with respect to an activated uplink component carrier and maximum transmit power configured for the activated uplink component carrier, a power information generation unit for generating a medium access control (MAC) message including a first field indicating the power headroom and a second field indicating the maximum transmit power, and an uplink information transmission unit for transmitting the MAC message to the BS.

The MAC message may include a MAC subheader and a MAC control element, the MAC subheader may include a logical channel identifier (LCID) indicating that the MAC control element includes both the first and second fields, the MAC control element may include first and second octets each having an 8-bit length, and the first octet may include the first field and the second octet includes the second field.

According to another aspect of the present invention, there is provided a base station (BS) for receiving power information regarding a component carrier in a multi-component carrier system. The BS may include: a scheduling unit for determining an uplink parameter required for a user equipment (UE) to perform an uplink transmission and configuring an uplink grant with the determined uplink parameter, an uplink information reception unit for receiving a medium access control (MAC) message including a first field indicating power headroom which can be additionally output by the UE with respect to an activated uplink component carrier and a second field indicating maximum transmit power configured for the activated uplink component carrier, and a downlink information transmission unit for transmitting, to the UE, an acknowledgement (ACK) indicating that the MAC message has been successfully received and the uplink grant.

The MAC message may include a MAC subheader and a MAC control element, the MAC subheader may include a logical channel identifier (LCID) indicating that the MAC control element includes both the first and second fields, the MAC control element may include first and second octets each having an 8-bit length, and the first octet may include the first field and the second octet includes the second field.

According to another aspect of the present invention, there is provided a method for transmitting maximum transmit power information by a user equipment (UE) in a multi-component carrier system. The transmission method may include: calculating maximum transmit power which can be output from an uplink component carrier; generating a medium access control (MAC) message including a first field indicating the maximum transmit power value; and transmitting the MAC message to a base station (BS). The MAC message may include a MAC control element. The MAC control element may be formed by octet, and a single octet may include the first field.

According to another aspect of the present invention, there is provided a method for receiving maximum transmit power information by a base station (BS) in a multi-component carrier system. The reception method may include: transmitting an uplink grant indicating uplink resource for a transmission of new uplink data to a user equipment (UE); and receiving a medium access control (MAC) message from the UE through the uplink resource. The MAC message may include a MAC control element. The MAC control element may be formed by octet, a single octet may include the first field, and the first field may indicate a maximum transmit power value which can be output from an uplink component carrier configured in the UE.

According to another aspect of the present invention, there is provided a user equipment (UE) transmitting maximum transmit power information in a multi-component carrier system. The UE may include: a downlink information reception unit receiving an uplink grant for a transmission of new uplink data and ACK (acknowledgement) indicating that a base station (BS) has successfully received maximum transmit power information indicating maximum transmit power that can be output from an uplink component carrier, from the BS; a calculation unit calculating the maximum transmit power; a maximum transmit power information generation unit generating the maximum transmit power information in the format of a medium access control (MAC) message; and an uplink information transmission unit transmitting the maximum transmit power information to the BS. The MAC message may include a MAC control element. The MAC control element may be formed by octet, and a single octet may include the first field.

According to another aspect of the present invention, there is provided a base station (BS) receiving maximum transmit power information in a multi-component carrier system. The BS may include: a scheduling unit determining an uplink parameter required for a user equipment (UE) to perform an uplink transmission, and configuring an uplink grant with the determined uplink parameter; an uplink information reception unit receiving the maximum transmit power information from the UE, and a downlink information transmission unit transmitting acknowledgement (ACK) indicating that the maximum transmit power information has been successfully received from the UE and the uplink grant to the UE. The maximum transmit power information may indicate maximum transmit power that can be output from an uplink component carrier configured in the UE.

According to embodiments of the present invention, since power headroom information and maximum transmit power information of each component carrier are incorporated into a single message, the structure of the message can be simplified and control information required for discriminating message types can be reduced. Meanwhile, when maximum transmit power of each component carrier is reported, existing control information used for reporting power headroom is shared, reducing an uplink signaling load. In addition, since the reporting of the maximum transmit power is based on the assumption of triggering for reporting power headroom, an overuse of reporting of maximum transmit power, thus effectively using uplink resource.

### BRIEF DESCRIPTION OF THE DRAWINGS

The above and other objects and features of the present invention will become apparent from the following description of preferred embodiments given in conjunction with the accompanying drawings, in which:

The accompanying drawings, which are included to provide a further understanding of the invention and are incorporated in and constitute a part of this specification, illustrate embodiments of the invention, and together with the description serve to explain the principles of the invention.

FIG. 1 shows a wireless communication system according to an embodiment of the present invention.

FIG. 2 is an explanatory diagram illustrating an intra-band contiguous carrier aggregation according to an embodiment of the present invention.

FIG. 3 is an explanatory diagram illustrating an intra-band non-contiguous carrier aggregation according to an embodiment of the present invention.

FIG. 4 is an explanatory diagram illustrating an inter-band carrier aggregation according to an embodiment of the present invention.

FIG. 5 shows a link between a DL CC (downlink component carrier) and a UL CC (uplink component carrier) in a multiple carrier system according to an embodiment of the present invention.

FIG. 6 is a graph showing an example of Power Headroom (PH), which is applied in the time-frequency axis according to an embodiment of the present invention.

FIG. 7 is a graph showing another example of PH, which is applied in the time-frequency axis according to an embodiment of the present invention.

FIG. 8 is a conceptual diagram illustrating the influence of uplink scheduling of a base station on the transmit power of a user equipment (UE) in a wireless communication system according to an embodiment of the present invention.

FIG. 9 is an explanatory diagram illustrating the power coordination amount and the maximum transmit power in a multiple component carrier system according to an embodiment of the present invention.

FIG. 10 is a block diagram showing the structure of a MAC PDU (MAC Protocol Data Unit) for reporting power coordination according to an embodiment of the present invention.

FIG. 11 shows the structure of carrier maximum transmit power information according to an embodiment of the present invention.

FIG. 12 is a block diagram showing the structure of carrier maximum transmit power information according to another embodiment of the present invention.

FIG. 13 is a block diagram showing the structure of a portion of a MAC PDU for reporting power coordination according to another embodiment of the present invention.

FIG. 14 is a block diagram showing the structure of a portion of a MAC PDU for reporting power coordination according to another embodiment of the present invention.

FIG. 15 is a block diagram showing the structure of a field mapping indicator according to an embodiment of the present invention.

FIG. 16 is a flow chart illustrating a process of a method for reporting carrier maximum transmit power according to an embodiment of the present invention.

FIG. 17 is a flow chart illustrating a process of a method for reporting carrier maximum transmit power by a user equipment (UE) according to an embodiment of the present invention.

FIG. 18 is a flow chart illustrating a process of a method for performing reporting of a carrier maximum transmit power by a user equipment (UE) according to another embodiment of the present invention.

FIG. 19 is a flow chart illustrating a process of a method for receiving a report of a carrier maximum transmit power by a base station (BS) according to another embodiment of the present invention.

FIG. 20 is a block diagram of a user equipment (UE) reporting carrier maximum transmit power and a base station (BS) receiving the report according to an embodiment of the present invention.

FIG. 21 is a view showing the structure of a MAC control element for reporting power according to an embodiment of the present invention.

FIG. 22 is a view showing the structure of a MAC control element for reporting power according to another embodiment of the present invention.

FIG. 23 is a view showing the structure of a MAC control element for reporting power according to another embodiment of the present invention.

FIG. 24 is a view showing the structure of a MAC control element for reporting power according to another embodiment of the present invention.

FIG. 25 is a view showing a serving cell indicator having an octet structure according to an embodiment of the present invention.

FIG. 26 is a view showing the structure of a MAC control element for reporting power according to another embodiment of the present invention.

FIG. 27 is a view showing a serving cell indicator having an octet structure according to another embodiment of the present invention.

FIG. 28 is a flow chart illustrating a method for reporting power according to an embodiment of the present invention.

FIG. 29 is a flow chart illustrating a process of a method for performing reporting of power according to an embodiment of the present invention.

FIG. 30 is a flow chart illustrating a process of a method for performing reporting of power according to another embodiment of the present invention.

FIG. 31 is a flow chart illustrating a process of method for receiving a report of power by a BS according to an embodiment of the present invention.

FIG. 32 is a block diagram showing a UE transmitting power information and a BS receiving power information according to an embodiment of the present invention.

### DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Further, in this disclosure, a wireless communication network is described. Tasks performed in the wireless communication network may be performed in a system (for example, a base station), such as a system for managing the wireless communication network or a system for controlling the network and transmitting data, or the tasks may be performed by a user equipment (UE) coupled to a network.

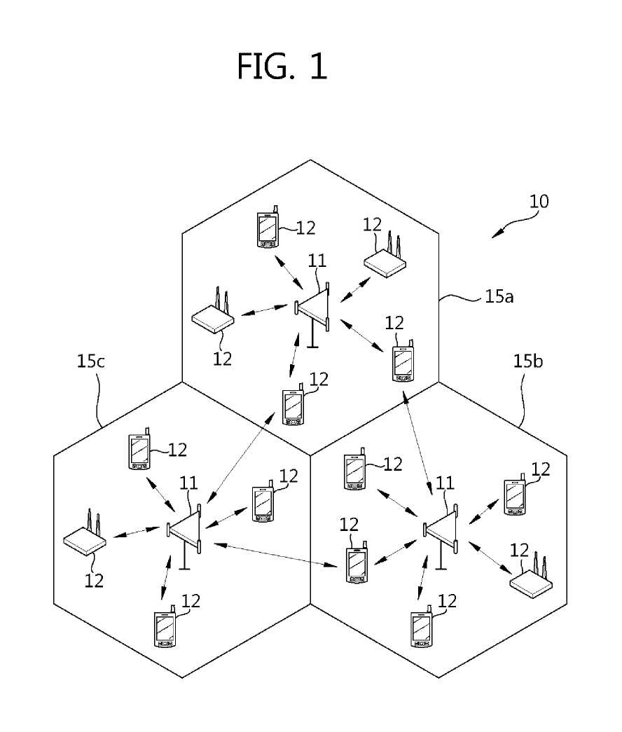

FIG. 1 shows a wireless communication system according to an embodiment of the present invention.

Referring to FIG. 1, the wireless communication systems 10 are deployed in order to provide a variety of communication services, such as voice and packet data transmission.

The wireless communication system 10 includes one or more Base Stations (BS) 11 (three are shown). Each BS 11 provides communication services to specific geographical areas (typically called cells) 15a, 15b, and 15c. The cell may be further classified into a plurality of areas (called sectors).

A user equipment (UE) 12 may be a fixed or mobile device and may also be referred to with other terminology, such as a Mobile Station (MS), a Mobile Terminal (MT), a User Terminal (UT), Subscriber Station (SS), a wireless device, a Personal Digital Assistant (PDA), a wireless modem; a handheld device, or the like.

The BS 11 refers to a station that communicates with each one of the various UE 12, and may also be referred to with other terminology, such as eNodeB (evolved NodeB: eNB), a BTS (Base Transceiver System), an access point or a relay. The cell may be interpreted as indicating some area covered by the BS 11. Various coverage areas of the cell may be used, such as a mega cell, a macro cell, a micro cell, a pico cell, and a femto cell.

Hereinafter, downlink (DL) refers to communication from the BS 11 to the UE 12, and uplink (UL) refers to communication from the UE 12 to the BS 11. In this case, in a downlink, a transmitter may be part of the BS 11, and a receiver may be part of the UE 12. Further, in uplink, a transmitter may be part of the UE 12, and a receiver may be part of the BS 11. In some cases, downlink may refer to communication from the UE 12 to the BS 11, and uplink may refer to communication from the BS 11 to the UE 12. In this case, in downlink, a transmitter may be part of the UE 12, and a receiver may be part of the BS 11. Further, in uplink, a transmitter may be part of the BS 11, and a receiver may be part of the UE 12.

A variety of multiple access schemes, such as CDMA (Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, and OFDM-CDMA, may be used with a wireless communication system. In uplink transmission and downlink transmission, a TDD (Time Division Duplex) scheme in which the transmission is performed using different times may be used or an FDD (Frequency Division Duplex) scheme in which the transmission is performed using different frequencies may be used.

The layers of a radio interface protocol between a UE and a network may be classified into a first layer L1, a second layer L2, and a third layer L3 on the basis of three lower layers of an Open System Interconnection (OSI), the OSI being known in the communication systems.

A physical layer (i.e., the first layer) is connected to a higher Medium Access Control (MAC) layer through a transport channel. Data between the MAC layer and the physical layer is moved through the transport channel. Further, data between different physical layers (i.e., the physical layers on the transmission side and on the reception side) is moved through a physical channel. There are some control channels that are available to be used in the physical layer. A Physical Downlink Control Channel (PDCCH) through which physical control information is transmitted informs a UE of the resource allocation of a PCH (paging channel) and a downlink shared channel (DL-SCH) and of Hybrid Automatic Repeat Request (HARQ) information related to the DL-SCH. The PDCCH may carry an uplink grant, informing a UE of the resource allocation of uplink transmission. A Physical Control Format Indicator Channel (PCFICH) is used to inform a UE of the number of OFDM symbols used in the PDCCHs and is transmitted for every frame. A Physical Hybrid ARQ Indicator Channel (PHICH) carries HARQ ACK/NAK signals in response to uplink transmission. A Physical Uplink Control Channel (PUCCH) carries the HARQ ACK/NAK signals for downlink transmission, a scheduling request, and uplink control information, such as Channel Quality Information (CQI). A Physical Uplink Shared Channel (PUSCH) carries a UL-SCH (uplink shared channel).

A situation in which a UE transmits the PUCCH or the PUSCH is described below.

A UE configures a PUCCH for one or more pieces of information about CQI, a PMI (Precoding Matrix Index) selected based on measured space channel information, and a Rank Indicator (RI) periodically transmits the configured PUCCH to a BS. Further, the UE transmits information about ACK/NACK (Acknowledgement/non-Acknowledgement) for downlink data to a BS after a certain number of sub-frames after receiving the downlink data. For example, if the downlink data is received in an n^{th} subframe, the UE transmits a PUCCH, composed of ACK/NACK information about the downlink data, in an (n+4)^{th} subframe. If all the pieces of ACK/NACK information cannot be transmitted on a PUCCH allocated by a BS or if a PUCCH on which ACK/NACK information can be transmitted is not allocated by a BS, a UE may carry the ACK/NACK information on a PUSCH.

A radio data link layer (i.e., the second layer) includes a MAC layer, an RLC layer, and a PDCP layer. The MAC layer is a layer responsible for mapping between a logical channel and a transport channel. The MAC layer selects a proper transport channel suitable for sending data received from the RLC layer and adds control information to the header of an MAC PDU (Protocol Data Unit). The RLC layer is placed over the MAC layer and configured to support reliable data transmission. Further, the RLC layer segments and concatenates RLC Service Data Units (SDUs) received from a higher layer in order to configure data to have a size suitable for a radio section. The RLC layer of a receiver supports a data reassembly function for recovering original RLC SDUs from received RLC PDUs. The PDCP layer is used only in a packet exchange region, and it can compress and send the header of an IP packet in order to increase the transmission efficiency of packet data in a radio channel.

An RRC layer (i.e., the third layer) functions to control a lower layer and also to exchange pieces of radio resource control information between a UE and a network. A variety of RRC states, such as an idle mode and an RRC connected mode, are defined according to the communication state of a UE. A UE may transfer between the various RRC states. Various procedures related to the management of radio resources, such as system information broadcasting, a RRC access management procedure, a multiple component carrier configuration procedure, a radio bearer control procedure, a security procedure, a measurement procedure, and a mobility management procedure (handover), may be defined in the RRC layer.

A carrier aggregation (CA) supports a plurality of carriers. The carrier aggregation may also be referred to as a spectrum aggregation or a bandwidth aggregation. An individual unit carrier aggregated by the carrier aggregation is called a Component Carrier (CC). Each CC is defined by the bandwidth and the center frequency. The carrier aggregation is introduced to support an increased throughput, prevent an increase of the costs due to the introduction of wideband RF (radio frequency) devices, and provide compatibility with the existing system. For example, if five CCs are allocated as the granularity of a carrier unit having a 5 MHz bandwidth, a maximum bandwidth of 20 MHz can be supported.

CCs are divided into an uplink CC and a downlink CC. Furthermore, an arbitrary CC pair in which the uplink CC and the downlink CC are linked with each other is called a cell.

CCs may be divided into a primary CC (hereinafter referred to as a PCC) and a secondary CC (hereinafter referred to as a SCC) based on whether they have been activated. The PCC is a carrier that is always remains activated, and the SCC is a carrier that is activated or deactivated according to a specific condition. The term ‘activation’ refers to the transmission or reception of traffic data is being performed or is in a standby state. The term ‘deactivation’ refers to the transmission or reception of traffic data is impossible, but measurement or the transmission/reception of minimum information is possible. A UE may use one PCC and one or more SCCs along with a PCC. A BS may allocate the PCC or the SCC or both to a UE.

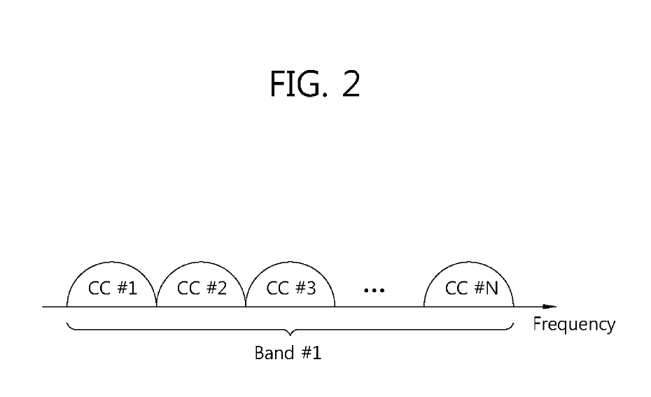

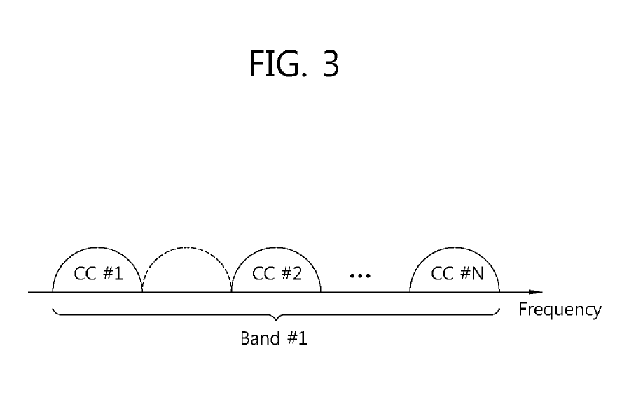

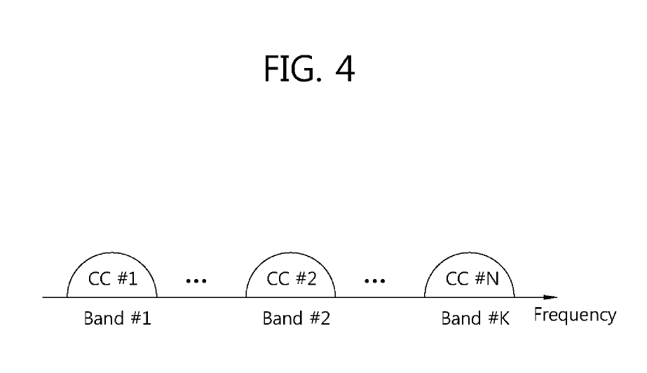

The carrier aggregation may be classified according to an exemplary embodiment into an intra-band contiguous carrier aggregation, such as that shown in FIG. 2, an intra-band non-contiguous carrier aggregation, such as that shown in FIG. 3, and an inter-band carrier aggregation, such as that shown in FIG. 4.

First, referring to FIG. 2, the intra-band contiguous carrier aggregation is formed between continuous CCs in the same band. For example, aggregated CCs, CC#1, CC#2, CC#3 to CC #N, are contiguous with each other.

Referring to FIG. 3, the intra-band non-contiguous carrier aggregation is formed between discontinuous CCs. For example, aggregated CCs, CC#1 and CC#2 are spaced apart from each other by a specific frequency.

Referring to FIG. 4, the inter-band carrier aggregation is of a type in which, if a plurality of CCs exists, one or more of the CCs are aggregated on different frequency bands. For example, an aggregated CC, CC 1 exists in a band #1, and an aggregated CC, CC 2 exists in a band #2.

The number of carriers aggregated in downlink and the number of carriers aggregated in uplink may be set differently. A case where the number of DL CCs is identical with the number of UL CCs is called a symmetric aggregation, and a case where the number of DL CCs is different from the number of UL CCs is called an asymmetric aggregation.

Further, CCs may have different sizes (i.e., bandwidths). For example, assuming that 5 CCs are used to configure a 70 MHz band, the configuration of the 70 MHz band may be a 5 MHz CC (carrier #0)+a 20 MHz CC (carrier #1)+a 20 MHz CC (carrier #2)+a 20 MHz CC (carrier #3)+a 5 MHz CC (carrier #4).

A multiple carrier system hereinafter refers to a system supporting the carrier aggregation. In the multiple carrier system, the contiguous carrier aggregation or the non-contiguous carrier aggregation or both may be used. Further, either a symmetric aggregation or an asymmetric aggregation may be used.

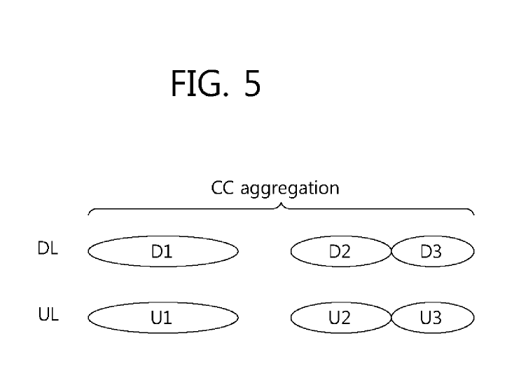

FIG. 5 shows a link between a DL CC (downlink component carrier) and a UL CC (uplink component carrier) in a multiple carrier system according to an embodiment of the present invention.

Referring to FIG. 5, in a downlink, Downlink Component Carriers (hereinafter referred to as ‘DL CC’) D1, D2, and D3 are aggregated. In an uplink, Uplink Component Carriers (hereinafter referred to as ‘UL CC’) U1, U2, and U3 are aggregated. Here, Di is the index of a DL CC, and Ui is the index of a UL CC (where i=1, 2, 3). At least one DL CC is a PCC, and the remaining CCs are SCCs. Likewise, at least one UL CC is a PCC, and the remaining CCs are SCCs. For example, D1 and U1 may be PCCs, and D2, U2, D3, and U3 may be SCCs.

In a FDD system, a DL CC and a UL CC are linked to each other in a one-to-one manner. Each of pairs of D1 and U1, D2 and U2, and D3 and U3 is linked to each other in a one-to-one manner. A UE sets up pieces of linkage between the DL CCs and the UL CCs based on system information transmitted on a logical channel BCCH or a UE-dedicated RRC message transmitted on a DCCH. Each of the pieces of linkage may be set up in a cell-specific way or a UE-specific way.

Only the 1:1 linkage between the DL CC and the UL CC is shown in FIG. 5, but a 1:n or n:1 linkage may also be set up. Further, the index of a component carrier does not comply with the sequence of the component carrier or the position of the frequency band of the component carrier.

Hereinafter, power headroom (PH) is described.

Power headroom refers to surplus power that may be additionally used other than power which is now being used by a UE for uplink transmission. For example, it is assumed that a UE has maximum transmit power of 10 W (i.e., uplink transmit power of an allowable range). It is also assumed that the UE is now using power of 9 W in the frequency band of 10 MHz. In this case, power headroom is 1 W because the UE can additionally use power of 1 W.

If a BS allocates a frequency band of 20 MHz to a UE, a power of 9 W×2=18 W is required. If the frequency band of 20 MHz is allocated to the UE, the UE may not use the entire frequency band because the UE has a maximum power of 10 W, or the BS may not properly receive signals from the UE due to the shortage of power. Thus, the UE may report the power headroom of 1 W to the BS so that the BS can perform scheduling within the range of the power headroom. This report is called a Power Headroom Report (PHR).

A periodic PHR method may be used if the power headroom is frequently changed. According to the periodic PHR method, when a periodic timer expires, a UE triggers a PHR. After reporting power headroom, the UE drives the periodic timer again.

Further, if a Path Loss (PL) estimate measured by a UE exceeds a certain reference value, the PHR may be triggered. The PL estimate is measured by a UE on the basis of Reference Symbol Received Power (RSRP).

Power headroom (P_{PH}) is defined as a difference between a maximum transmit power P_{cmax}, configured in a UE, and power P_{estimated} estimated in regard to uplink transmission as in Equation 1 and is represented by decibels (dB).

P_{PH}=P_{cmax}−P_{estimated} [dB] [Equation 1]

The power headroom P_{PH} may also be referred to as the remaining power or surplus power. That is, the remainder other than the estimated power P_{estimated} (i.e., the sum of transmitted powers used by CCs in a maximum transmit power of a UE configured by a BS), which becomes the P_{PH} value.

For example, the estimated power P_{estimated} is equal to the power P_{PUSCH} estimated in regard to the transmission of a Physical Uplink Shared Channel. In this case, the power headroom P_{PH} may be calculated according to Equation 2. The Equation 2 is a case where only PUSCH is transmitted in uplink and the P_{PH} is P_{PH} in type 1.

P_{PH}=P_{cmax}−P_{PUSCH}[dB] [Equation 2]

In another example, the estimated power P_{estimated} is equal to the sum of power P_{PUSCH} estimated in regard to the transmission of a PUSCH and power P_{PUCCH} estimated in regard to the transmission of a Physical Uplink Control Channel. In this case, the power headroom P_{PH} can be calculated by Equation 3. The Equation 3 is a case where both PUSCH and PUCCH are transmitted in uplink and the P_{PH} is P_{PH} in type 2.

P_{PH}=P_{cmax}−P_{PUCCH}−P_{PUSCH}[dB] [Equation 3]

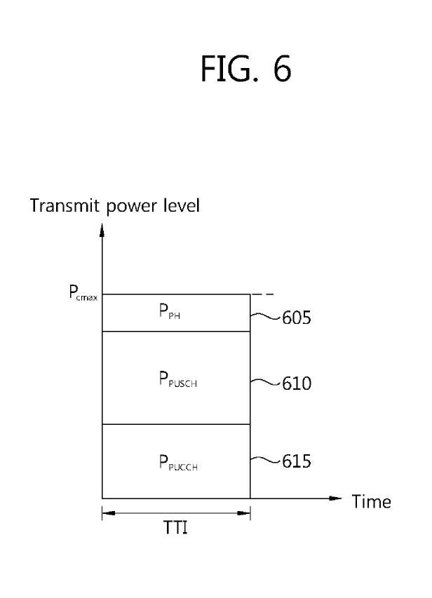

FIG. 6 is a graph showing an example of Power Headroom (PH), which is applied in the time-frequency axis according to an embodiment of the present invention.

If the power headroom according to Equation 3 is represented by a graph in the time-frequency axis, it results in FIG. 6. Referring to FIG. 6, the maximum transmit power P_{cmax} configured in a UE includes P_{PH} 605, P_{PUSCH} 610, and P_{PUCCH} 615. That is, the remaining power in which the P_{PUSCH} 610 and the P_{PUCCH} 615 have been subtracted from P_{cmax} is defined as the P_{PH} 605. Each power is calculated for each Transmission Time Interval (TTI).

A primary serving cell is a single serving cell which has a UL PCC through which a PUCCH can be transmitted. Accordingly, power headroom is defined as in Equation 2 because a secondary serving cell cannot send a PUCCH, and the operation and the parameters for the PHR method defined by Equation 3 are not defined.

On the other hand, in a primary serving cell, the operation and the parameters for the PHR method defined by Equation 3 may be defined. If a UE has to receive an uplink grant from a BS, send a PUSCH in a primary serving cell, and simultaneously send a PUCCH in the same subframe according to a predetermined rule, the UE calculates both the power headroom according to Equation 2 and the power headroom according to Equation 3 when a PHR is triggered, and transmits the calculated power headroom to a BS.

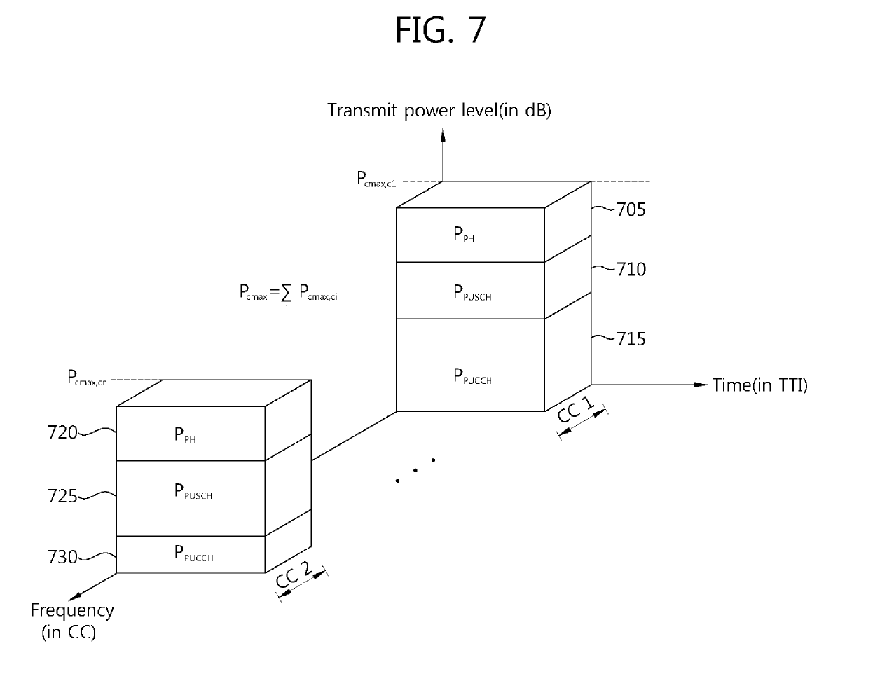

FIG. 7 is a graph showing another example of PH, which is applied in the time-frequency axis according to an embodiment of the present invention. In a multi-component carrier system, power headroom for each of a plurality of configured CCs may be defined, which may be represented as a graph in the time-frequency axis as shown in FIG. 7. Hereinafter, P_{cmax} is a maximum transmit power configured in a UE, P_{cmax,c} is P_{cmax} configured for each CC, and P_{cmax,c} for CC i is P_{cmax,ci}.

Referring to FIG. 7, a maximum transmit power P_{cmax} configured for a UE is equal to the sum of transmit powers P_{cmax,c1}, P_{cmax,c2} to P_{cmax,cN} for CC1, CC2 to CCN, respectively. The maximum transmit power for each CC may be generalized as in Equation 4 below.

$${P}_{{CC}_{i}} = {P}_{ma x} - {\sum }_{j \neq i} {P}_{{CC}_{j}} \qquad [ Equation 4 ]$$

The P_{PH} 705 of the CC1 is equal to ‘P_{cmax,c1}−P_{PUSCH} 710−P_{PUCCH} 715, and the P_{PH} 720 of the CCn is equal to P_{cmax,cn}−P_{PUSCH} 725−P_{PUCCH} 730. As described above, in a multiple component carrier system, a maximum transmit power of each CC must be taken into consideration to determine a maximum transmit power configured in a UE. Accordingly, the maximum transmit power configured in a UE in a multiple component carrier system is defined differently than a maximum transmit power in a single component carrier system.

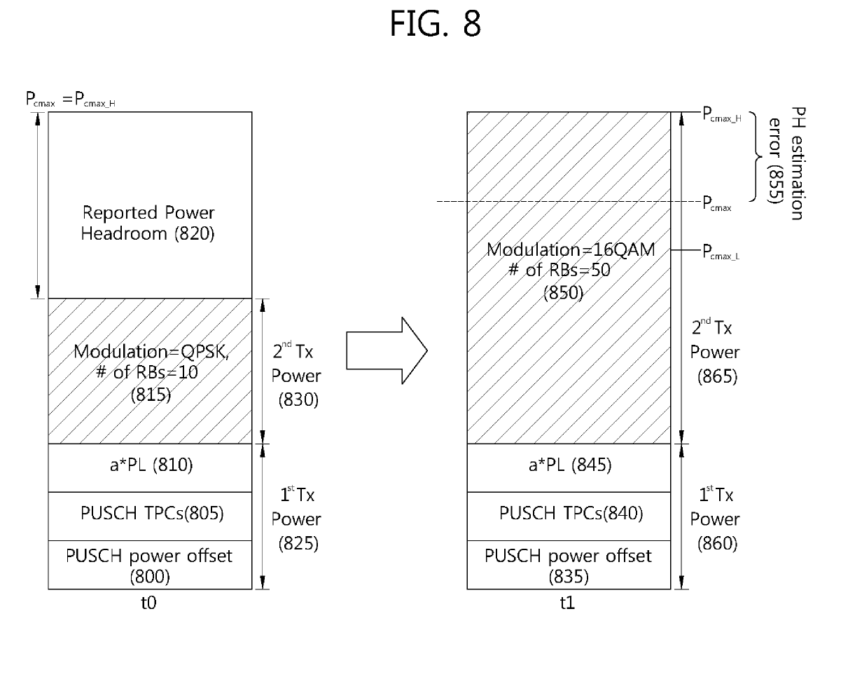

FIG. 8 is a conceptual diagram illustrating the influence of uplink scheduling of a base station on the transmit power of a mobile station in a wireless communication system according to an embodiment of the present invention.

Referring to FIG. 8, a UE receives an uplink grant, permitting uplink data transmission, from a BS through a PDCCH at time (or subframe) t0. Accordingly, the UE has to calculate the amount of transmit power in response to the uplink grant at a time t0.

First, at time t0, the UE calculates a first transmit (Tx) power 825 by taking ‘a value’ (received from the BS) (i.e., weight) into account in a PUSCH power offset (800) value received from the BS, a transmit power control (TPC, 805) value, and a path loss (PL) 810 between the BS and the UE. The first transmit power 825 is based on parameters, chiefly influenced by a path environment between the BS and the UE, and parameters determined by the policy of a network. In addition, the UE calculates a second transmit (Tx) power 830 by taking a scheduling parameter 815, indicating a QPSK modulation scheme included in the uplink grant and the allocation of ten resource blocks. The second transmit power 830 is a transmit power changed through the uplink scheduling of the BS.

Accordingly, the UE may calculate a final uplink transmit power by summing the first transmit power 825 and the second transmit power 830. Here, the final uplink transmit power may not exceed a configured maximum UE transmit power PC_{MAX}. In the example of FIG. 8, uplink information complying with the set parameters can be transmitted at the time t0 because the final transmit power is smaller than the value PC_{MAX}. Further, there is a power headroom 820 which is surplus for a transmit power that may be additionally allocated. The power headroom 820 is transmitted from the UE to the BS according to rules defined in a wireless communication system.

At a time t1, the BS changes the scheduling parameter 815 into a scheduling parameter 850, indicating a 16QAM modulation scheme and the allocation of 50 resource blocks, based on the information of the power headroom 820 by taking the transmit power that may be additionally allocated to the UE. The UE reconfigures a second transmit power 865 according to the scheduling parameter 850. The first transmit power 860 at the time t1 is determined by taking ‘a value’ (received from the BS) (i.e., weight) into account in a PUSCH power offset (835) value, a transmit power control (840) value, and a PL 845 between the BS and the UE. Here, it is assumed that the first transmit power 860 at the time t1 is equal to the first transmit power 825 at the time t0.

At time t1, P_{cmax} is changed to be close P_{Cmax}_{_{—}}_{L}, whereas the sum of the second transmit power 865 and the first transmit power 860 required by the scheduling parameter 850 exceeds P_{Cmax}. That is, there is a PH estimation value error 855 corresponding to ‘P_{Cmax}_{_{—}}_{H}-P_{Cmax}’. If scheduling for uplink resources is performed based on only PH information as described above, performance is degraded because a UE does not configure an uplink transmit power expected by a BS. If a component carrier aggregation method is used, the PH estimation value error 855 becomes larger.

In either a single component carrier system or a multiple component carrier system, a maximum transmit power configured in a UE is influenced by the power coordination of the UE. The term ‘power coordination’ refers to a maximum transmit power configured in a UE that is reduced within a permitted range, and the power coordination may also be called a Maximum Power Reduction (MPR). Further, the amount of power reduced by the power coordination is called a power coordination amount. The reason why a maximum transmit power configured in a UE is reduced is described below.

The range of a maximum transmit power in which power coordination is taken into account is as follows.

P_{cmax-L}≦P_{cmax}≦P_{cmax-H} [Equation 5]

Here, P_{cmax} is a maximum transmit power configured in a UE, P_{cmax-L} is a minimum value of P_{cmax}, and P_{cmax-H} is a maximum value of P_{cmax}. More particularly, P_{cmax-L} and P_{cmax-H} are calculated according to Equations below.

P_{cmax-L}=MIN[P_{Emax}−ΔT_{c},P_{power class}−PC−APC−ΔT_{c}] [Equation 6]

P_{cmax-H}=MIN[P_{Emax},P_{power class}] [Equation 7]

Here, MIN[a,b] is the smaller of values a and b, and P_{Emax} is a maximum power determined by the RRC signaling of a BS. ΔT_{C} is the amount of power which is used when there is uplink transmission at the edge of a frequency band, and it has 1.5 dB or 0 dB according to the bandwidth. P_{powerclass} is a power value according to several power classes defined in order to support various specifications of a UE in a system. In general, an LTE system supports a power class 3. P_{powerclass} according to the power class 3 is 23 dBm. PC is a power coordination amount, and APC (Additional Power Coordination) is an additional power coordination amount signaled by a BS.

The power coordination may be set to a specific range or may be set to a specific constant. The power coordination may be defined for every UE or may be defined for every CC. The power coordination may be set to a range or a constant within each CC. Further, the power coordination may be set to a range or a constant according to whether the PUSCH resource allocation of each CC is contiguous or non-contiguous. Further, the power coordination may be set to a range or a constant according to whether a PUCCH exists or not.

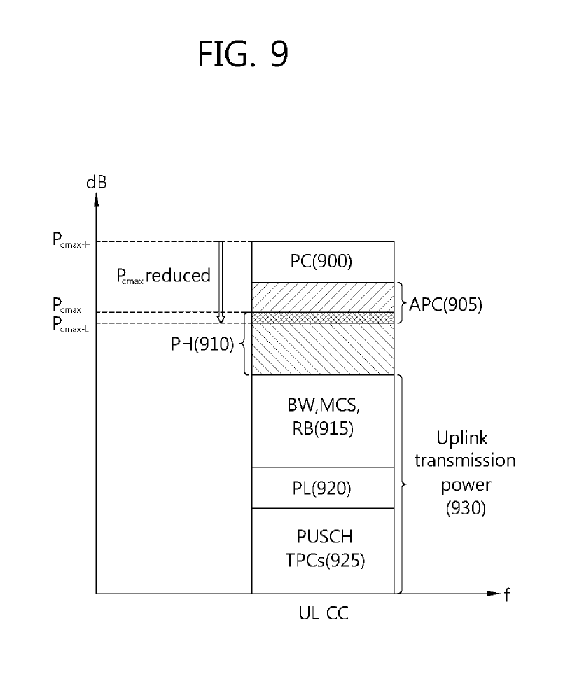

FIG. 9 is an explanatory diagram illustrating the power coordination amount and the maximum transmit power in a multiple component carrier system according to an embodiment of the present invention. It is assumed that only one UL CC is allocated to a UE, for convenience.

Referring to FIG. 9, assuming that ΔT_{C}=0, the maximum value P_{cmax-H} of the maximum transmit power P_{cmax} may be 23 dBm corresponding to the power class 3. The minimum value P_{cmax-L} of the maximum transmit power P_{cmax} is a value in which a power coordination amount (PC) 900 and an additional power coordination amount (APC) 905 have been subtracted from the maximum value P_{cmax-H}. That is, a UE reduces the minimum value P_{cmax-L} of the maximum transmit power P_{cmax} using the power coordination amount (PC) 900 and the additional power coordination amount (APC) 905. The maximum transmit power P_{cmax} is determined between the maximum value P_{cmax-H} and the minimum value P_{cmax-L}.

The uplink transmit power 930 is the sum of power 915 determined by a bandwidth BW, an MCS, and an RB, a PL 920, and PUSCH transmit power controls (TPC) 925. The PH 910 is a value in which the uplink transmit power 930 has been subtracted from the maximum transmit power P_{cmax}.

Only one UL CC has been described with reference to FIG. 9. If a plurality of UL CCs is allocated, the maximum transmit power may be determined for every UE and not for every UL CC. The maximum transmit power for each UE may be calculated as the sum of maximum transmit powers for all UL CCs.

In calculating the maximum transmit power P_{Emax}, ΔT_{C}, P_{powerclass}, and APC are information the BS knows or can know. However, the PC may be variable, so the maximum transmit power of the UE is accordingly varied. When the UE reports power headroom to the BS, the BS can merely roughly estimate the range of the maximum transmit power through the power headroom. The BS performs uncertain uplink scheduling within the estimated maximum transmit power, so in a worst case scenario, the BS may perform scheduling with a modulation/channel bandwidth/RB requiring transmit power greater than the maximum transmit power with respect to the UE. This problem may considerably arise in the multi-component carrier system. Thus, the UE is required to inform the BS about the amount or range of the maximum transmit power of each CC.

Hereinafter, maximum transmit power of each CC will be referred to as carrier maximum transmit power. The carrier maximum transmit power may be reported independently from power headroom, or may be reported together with power headroom. When the carrier maximum transmit power is independently reported, a triggering procedure for reporting the carrier maximum transmit power is required. Also, a unique message structure for reporting the carrier maximum transmit power is required.

Meanwhile, when the carrier maximum transmit power is reported together with power headroom, control information used for reporting power headroom may be applied to the reporting of the carrier maximum transmit power. For example, with respect to a carrier, reporting of power headroom and reporting of maximum transmit power may be performed together. In this case, an indicator indicating the carrier as a target for reporting power headroom is transmitted. Since the indicator is supposed to be transmitted, there may be a method for using the indicator in reporting the maximum transmit power, because there is no need to repeat the indicator required for reporting the maximum transmit power. Thus, the amount of information required for reporting the carrier maximum transmit power can be reduced.

Hereinafter, first, a definition and expression method of the maximum transmit power will be described. And, a condition for triggering the report of the carrier maximum transmit power, the structure of a message for reporting the carrier maximum transmit power, and an organic relationship between the procedure for reporting the carrier maximum transmit power between a UE and a BS and the report of power headroom will be described. Also, a condition and protocols required for establishing the organic relationship will also be described.

1. Definition and Expression Method of Carrier Maximum Transmit Power (P_{cmax.c})

Carrier maximum transmit power (P_{cmax.c}) is maximum transmit power that can be output per UL CC, which is expressed by dB. The carrier maximum transmit power may be give to as a range value such as 20 dB≦P_{cmax.c}<22 dB, or may be given as a constant such as P_{cmax.c}=20 dB. The carrier maximum transmit power may be set to be different for each UL CC, or may be set to be the same value. For example, UL CC1 may be set to be P_{cmax.c1}, and UL CC2 and UL CC3 may be set to be P_{cmax.c2}.

In order to represent the carrier maximum transmit power as it is, a large amount of information is required. If a UE consumes a large amount of uplink resource for reporting the carrier maximum transmit power to a BS, system performance may be possibly considerably degraded. Thus, a method for minimizing the amount of information required for reporting the carrier maximum transmit power is required.

In order to reduce the amount of information, the size of the carrier maximum transmit power may be quantized so as to be expressed by dB of a certain size, e.g., by 1 dB. Namely, P_{cmax.c} may be expressed by 1 dB, 2 dB, 3 dB, or the like. However, although the size of the carrier maximum transmit power is quantized, still a large amount of information is required for expressing the carrier maximum transmit power amount as it is.

According to an aspect of the present invention, the carrier maximum transmit power is divided into a level having a certain power range. There is a difference in dB of a certain size or a variable size between levels. The UE and the BS operate a range mapping table in which indexes are given to respective levels. The use of the range mapping table is effective because the size of the carrier maximum transmit power can be expressed by only indexes. The size of the range mapping table is determined according to the amount of information (e.g., the number of bits) used for reporting the carrier maximum transmit power. The reporting of the carrier maximum transmit power and the reporting of the carrier maximum transmit power are used to have the same meaning, and hereinafter, they will be called reporting of carrier maximum transmit power in terms of term unification.

For example, there is a different in dB of a certain size between the levels. Table 1 shows a range mapping table according to an embodiment of the present invention. It shows a case in which 3 bits are used to report the carrier maximum transmit power.

TABLE 1

| Index | P_{cmax.c} (dB) Range Report |
|---|---|
| 0 | P_{cmax.c} ≧ 22 (or 22 ≦ P_{cmax.c} ≦ 23) |
| 1 | 20 ≦ P_{cmax.c} < 22 |
| 2 | 18 ≦ P_{cmax.c} < 20 |
| 3 | 16 ≦ P_{cmax.c} < 18 |
| 4 | 14 ≦ P_{cmax.c} < 16 |
| 5 | 12 ≦ P_{cmax.c} < 14 |
| 6 | 10 ≦ P_{cmax.c} < 12 |
| 7 | P_{cmax.c} < 10 |

With reference to Table 1, the range of carrier maximum transmit power is divided into 8 levels. The indexes, having 3 bits, indicate the ranges of carrier maximum transmit power of 8 levels. For example, index 3 indicates that the range of carrier maximum transmit power is 16 dB≦P_{cmax.c}<18 dB. In this manner, one index is mapped to one carrier maximum transmit power. The UE may determine the range to which the carrier maximum transmit power belongs, and then, report the carrier maximum transmit power by the index mapped to the determined range. For example, when it is assumed that UL CC1 and UL CC2 are set for the UE. The UE may report index 2 with respect to UL CC1 and index 5 with respect to UL CC2 to the BS. Each level of the ranges of the carrier maximum transmit power has a difference of a certain size, i.e., by an interval of 2 dB.

The range of the carrier maximum transmit power in the range mapping table may vary according to a power class of the UE. The power class of the UE is maximum output power with respect to a certain transmission bandwidth within a channel bandwidth. For example, there are four types of power classes of the UE defined in the LTE system. Among them, a maximum transmit power defined in the power class 3 is 23 dB. The power class is measured by at least one subframe, and the range of a maximum power reduction (MPR) is set to be dependent on the power class.

Table 2 is a range mapping table according to another embodiment of the present invention. It shows a case in which 4 bits are used to report the carrier maximum transmit power, and there is a difference of 1 dB between levels of the carrier maximum transmit power.

TABLE 2

| Index | P_{cmax.c} (dB) Range Report |
|---|---|
| 0 | P_{cmax.c} ≧ 22 (or 22 ≦ P_{cmax.c} ≦ 23) |
| 1 | 21 ≦ P_{cmax.c} < 22 |
| 2 | 20 ≦ P_{cmax.c} < 21 |
| 3 | 19 ≦ P_{cmax.c} < 20 |
| 4 | 18 ≦ P_{cmax.c} < 19 |
| 5 | 17 ≦ P_{cmax.c} < 18 |
| 6 | 16 ≦ P_{cmax.c} < 17 |
| 7 | 15 ≦ P_{cmax.c} < 16 |
| 8 | 14 ≦ P_{cmax.c} < 15 |
| 9 | 13 ≦ P_{cmax.c} < 14 |
| 10 | 12 ≦ P_{cmax.c} < 13 |
| 11 | 11 ≦ P_{cmax.c} < 12 |
| 12 | 10 ≦ P_{cmax.c} < 11 |
| 13 | 9 ≦ P_{cmax.c} < 10 |
| 14 | 8 ≦ P_{cmax.c} < 9 |
| 15 | P_{cmax.c} < 8 |

With reference to Table 2, the range of the carrier maximum transmit power is divided into a total of 16 levels. The indexes, having 4 bits, indicate the range of carrier maximum transmit power of 16 levels. For example, index 3 indicates that the range of carrier maximum transmit power is 19 dB≦P_{cmax.c}<20 dB.

Table 3 is a range mapping table according to another embodiment of the present invention. It shows a case in which 4 bits are used to report the carrier maximum transmit power, and there is a difference of 2 dB between levels of the carrier maximum transmit power.

TABLE 3

| Index | P_{cmax.c} (dB) Range Report |
|---|---|
| 0 | P_{cmax.c} ≧ 22 (or 22 ≦ P_{cmax.c} ≦ 23) |
| 1 | 20 ≦ P_{cmax.c} < 22 |
| 2 | 18 ≦ P_{cmax.c} < 20 |
| 3 | 16 ≦ P_{cmax.c} < 18 |
| 4 | 14 ≦ P_{cmax.c} < 16 |
| 5 | 12 ≦ P_{cmax.c} < 14 |
| 6 | 10 ≦ P_{cmax.c} < 12 |
| 7 | 8 ≦ P_{cmax.c} < 10 |
| 8 | 6 ≦ P_{cmax.c} < 8 |
| 9 | 4 ≦ P_{cmax.c} < 6 |
| 10 | 2 ≦ P_{cmax.c} < 4 |
| 11 | 0 ≦ P_{cmax.c} < 2 |
| 12 | Reserved |
| 13 | Reserved |
| 14 | Reserved |
| 15 | Reserved |

With reference to Table 3, the range of the carrier maximum transmit power is divided into a total of 16 levels. The indexes, having 4 bits, indicate the range of carrier maximum transmit power of 16 levels. Since there is a difference of 2 dB between levels, the range of maximum transmit power of level 11 is 0 dB≦P_{cmax.c}<2 dB. Since the maximum transmit power must be greater than 0, there is no range of maximum transmit power mapped to the remaining indexes 12 to 15. Thus, the indexes 12 to 15 remain as reserved code points.

Table 4 is a range mapping table according to another embodiment of the present invention. It shows a case in which 5 bits are used to report the carrier maximum transmit power, and there is a difference of 1 dB between levels of the carrier maximum transmit power.

TABLE 4

| Index | P_{cmax.c} (dB) Range Report |
|---|---|
| 0 | P_{cmax.c} ≧ 22 (or 22 ≦ P_{cmax.c} ≦ 23) |
| 1 | 21 ≦ P_{cmax.c} < 22 |
| 2 | 20 ≦ P_{cmax.c} < 21 |
| 3 | 19 ≦ P_{cmax.c} < 20 |
| 4 | 18 ≦ P_{cmax.c} < 19 |
| 5 | 17 ≦ P_{cmax.c} < 18 |
| 6 | 16 ≦ P_{cmax.c} < 17 |
| 7 | 15 ≦ P_{cmax.c} < 16 |
| 8 | 14 ≦ P_{cmax.c} < 15 |
| 9 | 13 ≦ P_{cmax.c} < 14 |
| 10 | 12 ≦ P_{cmax.c} < 13 |
| 11 | 11 ≦ P_{cmax.c} < 12 |
| 12 | 10 ≦ P_{cmax.c} < 11 |
| 13 | 9 ≦ P_{cmax.c} < 10 |
| 14 | 8 ≦ P_{cmax.c} < 9 |
| 15 | 7 ≦ P_{cmax.c} < 8 |
| 16 | 6 ≦ P_{cmax.c} < 7 |
| 17 | 5 ≦ P_{cmax.c} < 6 |
| 18 | 4 ≦ P_{cmax.c} < 5 |
| 19 | 3 ≦ P_{cmax.c} < 4 |
| 20 | 2 ≦ P_{cmax.c} < 3 |
| 21 | 1 ≦ P_{cmax.c} < 2 |
| 22 | 0 ≦ P_{cmax.c} < 1 |
| 23 | Reserved |
| 24 | Reserved |
| 25 | Reserved |
| 26 | Reserved |
| 27 | Reserved |
| 28 | Reserved |
| 29 | Reserved |
| 30 | Reserved |
| 31 | Reserved |

With reference to Table 4, the range of the carrier maximum transmit power is divided into a total of 32 levels. The indexes, having 5 bits, indicate the range of carrier maximum transmit power of 32 levels. For example, index 19 indicates that the range of carrier maximum transmit power is 3 dB≦P_{cmax.c}<4 dB. Since the maximum transmit power must be greater than 0, there is no range of maximum transmit power mapped to the remaining indexes 23 to 31. Thus, the indexes 23 to 31 remain as reserved code points.

In another example, there is a difference in dB having a variable size between levels. Table 5 is a range mapping table according to another embodiment of the present invention. It shows a case in which 4 bits are used to report the carrier maximum transmit power.

TABLE 5

| Index | P_{cmax.c} (dB) Range Report |
|---|---|
| 0 | P_{cmax.c} ≧ 22 (or 22 ≦ P_{cmax.c} ≦ 23) |
| 1 | 20 ≦ P_{cmax.c} < 22 |
| 2 | 18 ≦ P_{cmax.c} < 20 |
| 3 | 16 ≦ P_{cmax.c} < 18 |
| 4 | 14 ≦ P_{cmax.c} < 16 |
| 5 | 12 ≦ P_{cmax.c} < 14 |
| 6 | 10 ≦ P_{cmax.c} < 12 |
| 7 | 8 ≦ P_{cmax.c} < 10 |
| 8 | 7 ≦ P_{cmax.c} < 8 |
| 9 | 6 ≦ P_{cmax.c} < 7 |
| 10 | 5 ≦ P_{cmax.c} < 6 |
| 11 | 4 ≦ P_{cmax.c} < 5 |
| 12 | 3 ≦ P_{cmax.c} < 4 |
| 13 | 2 ≦ P_{cmax.c} < 3 |
| 14 | 1 ≦ P_{cmax.c} < 2 |
| 15 | 0 ≦ P_{cmax.c} < 1 |

With reference to Table 5, the range of the carrier maximum transmit power is divided into a total of 16 levels. The indexes, having 4 bits, indicate the range of carrier maximum transmit power of 16 levels. There is a difference of 2 dB between levels from level 0 (index 0) to level 7 (index 7), and there is a difference of 1 dB between levels from level 8 (index 8) to level 15 (index 15). Namely, the difference in size between levels is variable.

In comparison to Table 5, there may be a case in which levels of lower indexes may have a difference of 2 dB and levels of upper indexes may have a difference of 1 dB. Table 6 shows this case.

TABLE 6

| Index | P_{cmax.c} (dB) Range Report |
|---|---|
| 0 | P_{cmax.c} ≧ 22 (or 22 ≦ P_{cmax.c} ≦ 23) |
| 1 | 21 ≦ P_{cmax.c} < 22 |
| 2 | 20 ≦ P_{cmax.c} < 21 |
| 3 | 19 ≦ P_{cmax.c} < 20 |
| 4 | 18 ≦ P_{cmax.c} < 19 |
| 5 | 17 ≦ P_{cmax.c} < 18 |
| 6 | 16 ≦ P_{cmax.c} < 17 |
| 7 | 15 ≦ P_{cmax.c} < 16 |
| 8 | 14 ≦ P_{cmax.c} < 15 |
| 9 | 12 ≦ P_{cmax.c} < 14 |
| 10 | 10 ≦ P_{cmax.c} < 12 |
| 11 | 8 ≦ P_{cmax.c} < 9 |
| 12 | 6 ≦ P_{cmax.c} < 8 |
| 13 | 4 ≦ P_{cmax.c} < 6 |
| 14 | 2 ≦ P_{cmax.c} < 4 |
| 15 | 0 ≦ P_{cmax.c} < 2 |

With reference to Table 6, there is a difference of 1 dB between levels of upper indexes of 0 to 8, and there is a difference of 2 dB between levels of lower indexes 9 to 15.

In comparison to Table 1 to Table 6, a table may be configured by setting a difference of dB at each level of lower indexes based on P_{powerclass}. Table 7 shows this.

TABLE 7

| Index | P_{cmax.c} (dB) Range Report |
|---|---|
| 0 | P_{powerclass} |
| 1 | P_{powerclass} − 1 ≦ P_{cmax.c} < P_{powerclass} |
| 2 | P_{powerclass} − 2 ≦ P_{cmax.c} < P_{powerclass} − 1 |
| 3 | P_{powerclass} − 3 ≦ P_{cmax.c} < P_{powerclass} − 2 |
| 4 | P_{powerclass} − 4 ≦ P_{cmax.c} < P_{powerclass} − 3 |
| 5 | P_{powerclass} − 5 ≦ P_{cmax.c} < P_{powerclass} − 4 |
| 6 | P_{powerclass} − 6 ≦ P_{cmax.c} < P_{powerclass} − 5 |
| 7 | P_{powerclass} − 7 ≦ P_{cmax.c} < P_{powerclass} − 6 |
| 8 | P_{powerclass} − 8 ≦ P_{cmax.c} < P_{powerclass} − 7 |
| 9 | P_{powerclass} − 9 ≦ P_{cmax.c} < P_{powerclass} − 8 |
| 10 | P_{powerclass} − 10 ≦ P_{cmax.c} < P_{powerclass} − 9 |
| 11 | P_{powerclass} − 11 ≦ P_{cmax.c} < P_{powerclass} − 10 |
| 12 | P_{powerclass} − 12 ≦ P_{cmax.c} < P_{powerclass} − 11 |
| 13 | P_{powerclass} − 13 ≦ P_{cmax.c} < P_{powerclass} − 12 |
| 14 | P_{powerclass} − 14 ≦ P_{cmax.c} < P_{powerclass} − 13 |
| 15 | P_{powerclass} − 15 ≦ P_{cmax.c} < P_{powerclass} − 14 |

With reference to Table 7, there is a difference of 1 dB between levels of all the indexes.

Table 1 to Table 7 show examples of indicating carrier maximum transmit power, which use the range mapping tables. The number of levels of the ranges of the carrier maximum transmit power, the difference in size between levels, and the size of the ranges are all merely illustrative without limiting the technical concept of the present invention. In addition, classifying the carrier maximum transmit power by levels, differentiating the levels by a fixed size or variable size, and expressing the respective levels by a certain range shall be all included in the technical concept of the present invention.

2. Structure of Information for Reporting Carrier Maximum Transmit Power (P_{cmax.c}).

Information used for reporting carrier maximum transmit power may be upper layer signaling, e.g., a message of an RRC layer or a message of a MAC layer. Or, the information may be signaling of lower layer, such as a physical layer. Hereinafter, a method for configuring information for reporting carrier maximum transmit power, as a message of a MAC layer will be described in detail.

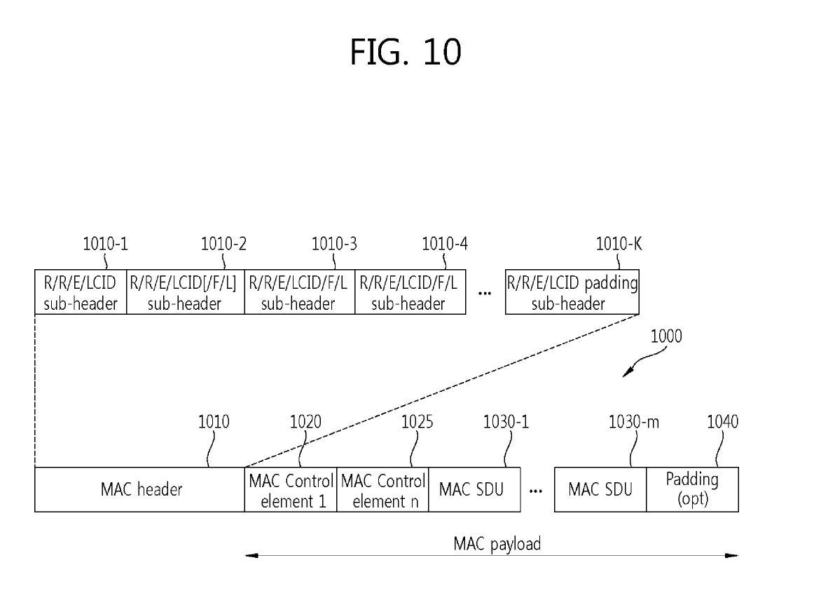

FIG. 10 is a block diagram showing the structure of a MAC PDU (MAC Protocol Data Unit) for reporting carrier maximum transmit power according to an embodiment of the present invention. MAC PDU is also called a Transport Block (TB).

With reference to FIG. 10, a MAC PDU 1000 includes a MAC header 1010, one or more MAC control elements 1020 to 1025, one or more MAC SDUs (Service Data Units) 1030-1 to 1030-m, and padding 1040.

The MAC control elements 1020 and 1025 are control messages generated by the MAC layer.

MAC SDU 1030-1 to 1030-m are equal to an RLC PDU transferred from an RLC (Radko Link Control) layer. The padding 1040 is a certain number of bits added to make the size of the MAC PDUs uniform. The MAC control elements 1020 to 1025, MAC SDUs 1030-1 to 1030-m, and the padding 1040 are collectively called MAC payload.

The MAC header 1010 includes one or more subheaders 1010-1, 1010-2, . . . , 1010-k, and each of the subheadets 1010-1, 1010-2, . . . , 1010-k correspond to one MAC SDU, one MAC control element, or the padding. The subheaders 1010-1, 1010-2, . . . , 1010-k are disposed in same order of the corresponding MAC SDUs, the MAC control elements, or the padding within the MAC PDU 1000.

The respective subheaders 1010-1, 1010-2, . . . , 1010-k may include four fields of R, R, E, LCID or six fields of R, R, E, LCID, F, L. The subheader including the four fields is a subheader corresponding to the MAC control element or the padding, and the subheader including the six fields is a subheader corresponding to the MAC SDUs.

A logical channel identification information (LCID) field may identify (or discriminate) a logical channel corresponding to the MAC SDUs or identify the MAC control elements or a type of padding, which may have 5 bits.

For example, the LCID field discriminates whether or not a corresponding MAC control element is power headroom MAC control element for a transmission of power headroom (PH), whether or not it is a feedback request MAC control element requesting feedback information from a UE, whether or not it is a discontinuous reception (DRX) command MAC control element regarding a DRX command, whether or not it is a contention resolution identity MAC control element for resolving contention between UEs.

Also, the LCID field may discriminate whether or not a corresponding MAC control element is a MAC control element for reporting carrier maximum power (P_{cmax.c}) (referred to as a ‘MAC control element for reporting power’, hereinafter). One LCID field exists for each of the MAC SDU, MAC control element, or padding. Table 8 is an example of the LCID field.

TABLE 8

| Index | LCID values |
|---|---|
| 00000 | CCCH |
| 00001-01010 | Identity of logical channel |
| 01011-10110 | Reserved |
| 10111 | P_{cmax.c} Report |
| 11000 | Secondary cell (S-cell) activation/deactivation |
| 11001 | Reference CC Indicator |
| 11010 | Power Headroom Report |
| 11011 | C-RNTI |
| 11100 | Truncated BSR |
| 11101 | Short BSR |
| 11110 | Long BSR |
| 11111 | Padding |

With reference to Table 8, the LCID field value of 10111 may indicate that a corresponding MAC control element is a MAC control element for reporting power according to an embodiment of the present invention.

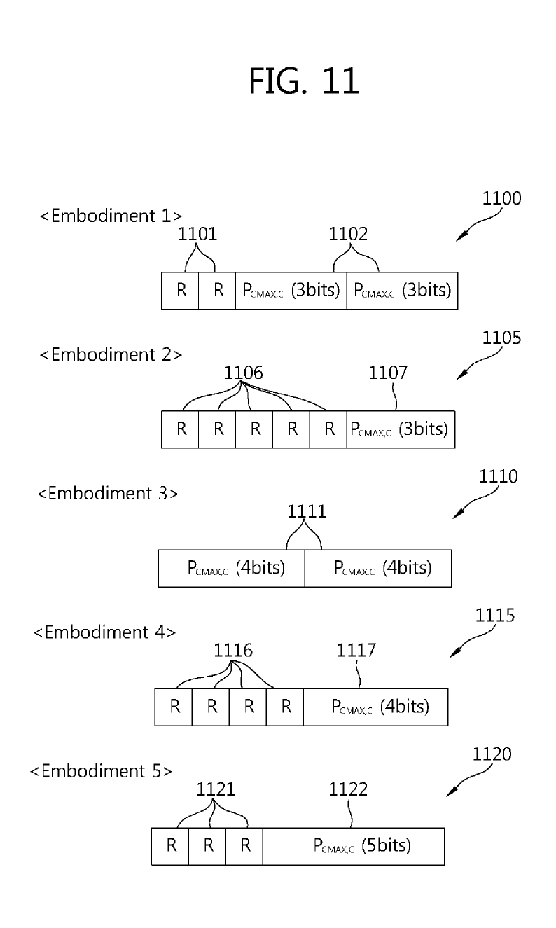

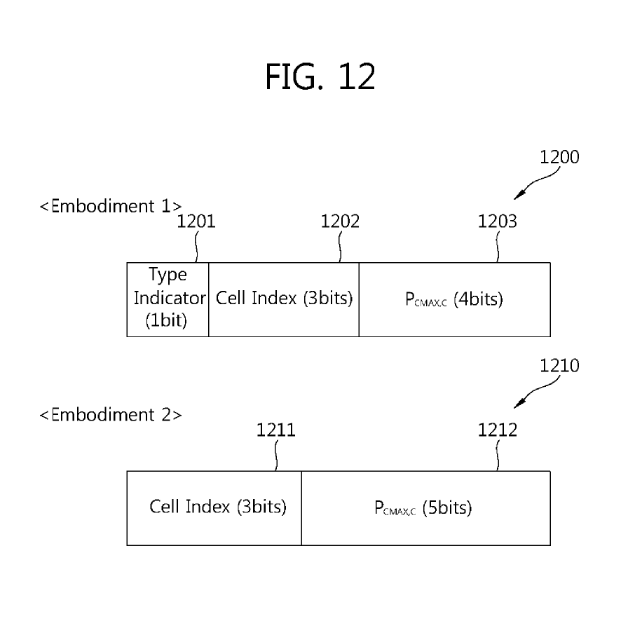

For example, when the LCID field value indicates 10111, the corresponding MAC control element for reporting power may include power headroom (PH) information and carrier maximum transmit power information (P_{cmax,c} Information). The PH information includes at least one PH field (PHF) and a relevant additional field. The carrier maximum transmit power information includes at least one carrier maximum transmit power field and a relevant additional field. The carrier maximum transmit power information will be described in detail with reference to FIGS. 11 and 12.

In another example, the LCID field value indicating 10111 may be set to have a meaning that it indicates a transmission of PH information and also have a meaning that a transmission of P_{cmax.c} is additionally included. Or, the LCID field value indicating 10111 may be set to define a new term (e.g., power information of each uplink component carrier) indicating a transmission of P_{cmax.c} and the PH.

FIG. 11 shows the structure of carrier maximum transmit power information according to an embodiment of the present invention.

With reference to FIG. 11, carrier maximum transmit power information is comprised of at least one octet. One octet is an information unit having a length of 8 bits, which includes at least one carrier maximum transmit power field (P_{cmax,c} field). Or, the carrier maximum transmit power information include at least one R field.

Embodiment 1 1100 and Embodiment 2 1105 are cases in which the carrier maximum transmit power field has 3 bits. Thus, one octet may include a maximum of two carrier maximum transmit power fields. Embodiment 1 1100 is a case in which one octet includes a maximum transmit power field 1102 with respect to two carriers, and Embodiment 2 1105 is a case in which one octet includes a maximum transmit power field 1107 with respect to one carrier. Bits remaining after being used for the carrier maximum transmit power field make R fields. Namely, in Embodiment 1 1100, the octet includes two R fields 1101, and in Embodiment 2 1105, the octet includes five R fields 1106. One carrier maximum transmit power field includes a maximum transmit power value with respect to one CC.

Embodiment 3 1110 and Embodiment 4 1115 show octet in which the carrier maximum transmit power field has 4 bits. Embodiment 3 1110 is a case in which one octet includes two carrier maximum transmit power field 1111, and Embodiment 4 1115 is a case in which one octet includes one carrier maximum transmit power field 1117. Bits remaining after being used for the carrier maximum transmit power fields make R fields. Namely, Embodiment 3 1110 does not have an R field in the octet, and Embodiment 4 1115 has the octet including four R fields 1116.

Embodiment 5 1120 has an octet when the carrier maximum transmit power field has 5 bits. Thus, the octet includes one carrier maximum transmit power field 1122 and three R fields 1121.

FIG. 12 is a block diagram showing the structure of carrier maximum transmit power information according to another embodiment of the present invention.

With reference to FIG. 12, carrier maximum transmit power information includes at least one octet. One octet is an information unit having a length of 8 bits, and includes at least one carrier maximum transmission power field (P_{cmax,c} field). Embodiment 1 1200 is a case in which one octet includes a type indicator field 1201, a cell index field 1202, and a carrier maximum transmit power field (P_{cmax,c} field) 1203. The type indication field 1201 discriminates whether or not carrier maximum transmission power of UL CC of a serving cell corresponding to the carrier maximum transmit power field 1203 is type 1 or type 2. The carrier maximum transmit power field 1203 indicates carrier maximum transmit power of UL CC by a level of the power range as shown in Table 1 to Table 8, and the cell index field 1202 indicates an index of a serving cell including the UL CC.

Embodiment 2 1210 is a case in which one octet includes a cell index field 1211 and a carrier maximum transmit power field 1212. Namely, one octet may include at least two of the carrier maximum transmit power field, the cell index field, and the type indication field.

Besides, one octet may include at least one carrier maximum transmit power field. Or, one octet may include at least one cell index field. Or, one octet may include at least one type indication field.

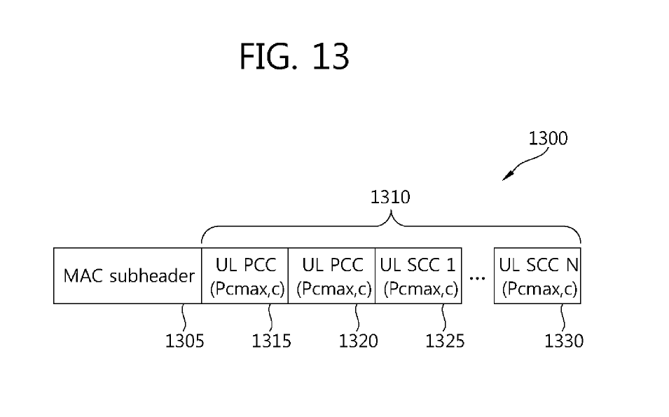

FIG. 13 is a block diagram showing the structure of a portion of a MAC PDU for reporting carrier maximum transmit power according to another embodiment of the present invention. In FIG. 13, the MAC PDU has a structure for reporting carrier maximum transmit power with respect to every UL CC belonging to an activated serving cell.

With reference to FIG. 13, the MAC PDU 1300 includes a MAC subheader 1305 and a MAC control element 1310.

The MAC control element 1310 includes at least one carrier maximum transmit power field. For example, the MAC control element 1310 may include a carrier maximum transmit power field 1315 and/or a carrier maximum transmit power field 1320. The carrier maximum transmit power field 1315 is a field indicating a carrier maximum transmit power value when Type 1 is considered for the UL PCC belonging to a primary serving cell. Meanwhile, the carrier maximum transmit power field 1320 is a field indicating a carrier maximum transmit power value when Type 2 is considered for the UL PCC belonging to the primary serving cell. As described above, only the PUSCH may be transmitted on the UL PCC of the primary serving cell (Type 1) or the PUCCH and the PUSCH may be simultaneously transmitted (Type 2). Thus, the carrier maximum transmit power fields exist as a pair with respect to the UL PCC. The UE may inform the BS about the carrier maximum transmit power regarding Type 1 and Type 2 through the MAC PDU 1300 structure.

Next, only Type 1 exists for the UL SCC belonging to the secondary serving cell, so the MAC control element 1310 includes one carrier maximum transmit power field 1325, . . . 1330 for every activated UL SCC.

The MAC control element 1310 includes a carrier maximum transmit power field with respect to every activated UL CC. When the array order of the carrier maximum transmit power fields are previously agreed between the UE and the BS, the BS may map the carrier maximum transmit power fields in order to corresponding UL CCs. Thus, an indicator indicating to which UL CC a carrier maximum transmit power field is related may not be required. In this case, the MAC control element 1310 may further include such R fields in addition to the carrier maximum transmit power fields as in the various embodiments of FIG. 11.

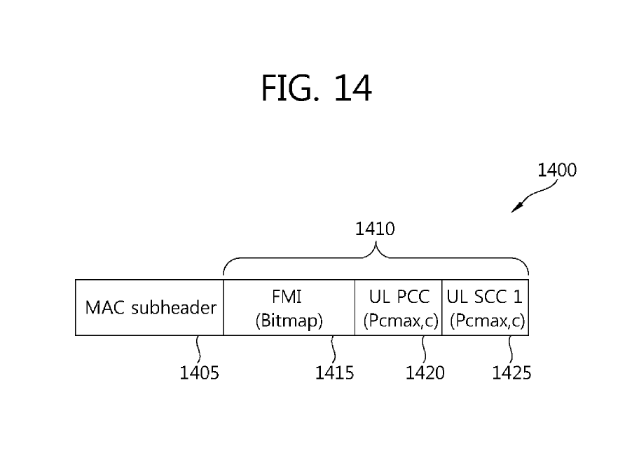

FIG. 14 is a block diagram showing the structure of a portion of a MAC PDU for reporting power coordination according to another embodiment of the present invention. In FIG. 14, the MAC PDU has a structure for reporting only carrier maximum transmit power with respect to some UL CCs selected from among all the UL CCs belonging to an activated serving cell. Here, the selected some of UL CCs refer to UL CCs having a certain reference, e.g., the variation (ΔP_{cmax,c}), greater than a threshold value.

With reference to FIG. 14, the MAC PDU 1400 includes a MAC subheader 1405 and a MAC control element 1410.

The MAC control element 1410 includes a field mapping indicator (FMI) 1415 and one or more carrier maximum transmit power fields 1420 and 1425. The FMI 1415 indicates UL CCs to which the carrier maximum transmit power fields 1420 and 1425 within the MAC control element 1410 are mapped. The FMI 1415 has a bitmap form, and UL CCs to which each bit is mapped are fixed. For example, when the FMI 1415 is ‘abc’, a is mapped to UL CC1, b is mapped to UL CC2, and c is mapped to UL CC3. Meanwhile, each bit may indicate whether or not the carrier maximum transmit power fields 1420 and 1425 with respect to particular UL CCs are included in the MAC control element 1410 by 0 or 1.

Since the MAC control element 1410 includes the FMI 1415, a cell index field indicating to which carriers the carrier maximum transmit power fields 1420 and 1420 are related is not required. Thus, in this case, the MAC control element 1410 may further include such R fields in addition to the carrier maximum transmit power fields as in the various embodiments of FIG. 11.

Meanwhile, the MAC control element 1410 may have such a form including the maximum transmit power field and the cell index field together as in the various embodiments in FIG. 12.

The MAC control element 1410 may include at least one of carrier maximum transmit power field 1 and carrier maximum transmit power field 2, or may not include any of them. Here, the carrier maximum transmit power field 1 is a field indicating a carrier maximum transmit power value in case in which Type 1 is considered for the UL PCC belonging to the primary serving cell. Meanwhile, the carrier maximum transmit power field 2 is a field indicating a carrier maximum transmit power value in case in which Type 2 is considered for the UL PCC belonging to the primary serving cell.

For example, when at least one of variations of the carrier maximum transmit power of Type 1 and Type 2 is greater than a threshold value, the MAC control element 1410 include both of the carrier maximum transmit power field 1 and the carrier maximum transmit power field 2. Meanwhile, when the variations of the carrier maximum transmit power of Type 1 and Type 2 are all smaller than the threshold value, the MAC control element 1410 do not include any of the carrier maximum transmit power field 1 and the carrier maximum transmit power field 2.

In another example, it is assumed that the UE is currently set in the Type 1 mode by the BS and transmits only the PUSCH. In this case, when a variation of the carrier maximum transmit power of Type 1 is greater than the threshold value, the MAC control element 1410 includes the carrier maximum transmit power field 1, or otherwise, the MAC control element 1410 does not include the carrier maximum transmit power field 1.

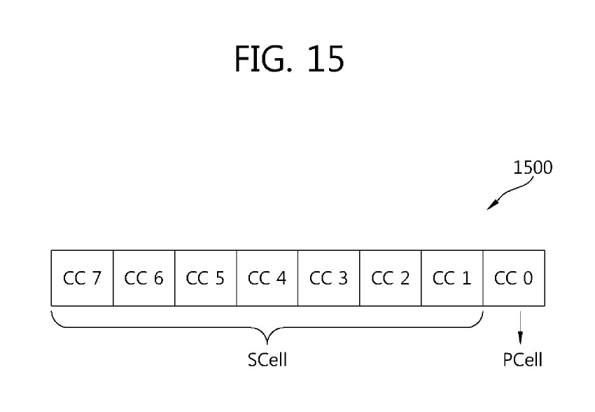

FIG. 15 is a block diagram showing the structure of a field mapping indicator according to an embodiment of the present invention.

With reference to FIG. 15, a field mapping indicator 1500 has a length of 8 bits in case of an octet structure. The 8 bits indicate whether or not CC0, CC1, CC2, . . . , CC7 include a carrier maximum transmit power field, sequentially from the rightmost. CC0 indicates a primary serving cell all the time, and CC1 to CC7 follow the serving cell index of the secondary serving cell. When the value of each bit is 1, it indicates that the carrier maximum transmit power field with respect to the UL CC of the corresponding serving cell is included in the MAC control element.

Here, in case in which a bit value corresponding to CC0 is 1, only when the UE is set to the Type 2 mode in which the PUSCH and the PUCCH are simultaneously transmitted through the primary serving cell, the bit value 1 indicates that the carrier maximum transmit power fields with respect to Type 1 and Type 2 for the UL CC of the primary serving cell are included in the MAC control element. Meanwhile, when the UE is not set to the Type 2 mode, only the carrier maximum transmit power field with respect to Type 1 for the UL CC of the primary serving cell is included in the MAC control element.

Procedure of reporting carrier maximum transmit power

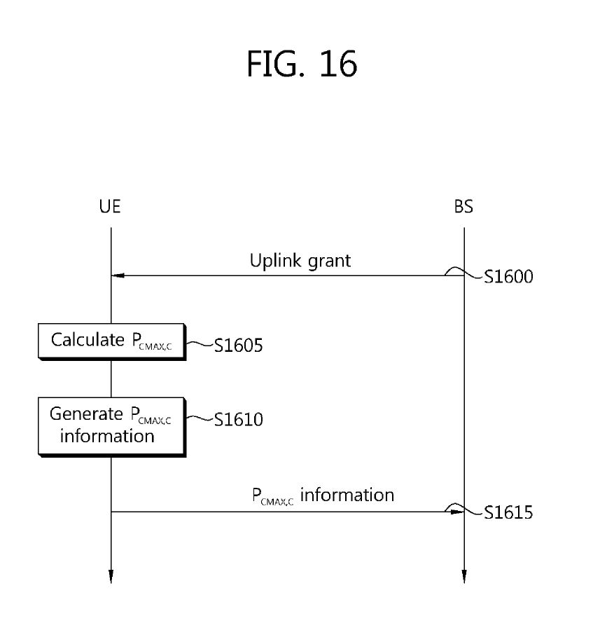

FIG. 16 is a flow chart illustrating a process of a method for reporting carrier maximum transmit power according to an embodiment of the present invention.

With reference to FIG. 16, the BS transmits an uplink transmit to the UE (S1600). The uplink grant is information corresponding to format 0 of downlink control information (DCI) transmitted via a PDCCH, which includes information such as RF, modulation and coding scheme (MCS), TPC, or the like. Table 9 shows an example of the uplink grant.

```
TABLE 9
- Flag for format0/format1A differentiation - 1 bit, where value 0 indicates format 0 and value 1 indicates
  format 1A
- Frequency hopping flag - 1 bit
- Resource block assignment and hopping resource allocation- [log₂(N_{RB}^{UL}(N_{RB}^{UL} +1)/2)] bits
  - For PUSCH hopping:
    - N_{UL}_hop MSB bits are used to obtain the value of ñ_{PRB}(i)
    - ([log₂(N_{RB}^{UL}(N_{RB}^{UL} +1)/2)] − N_{UL}_hop) bits provide the resource allocation of the first slot in the
    UL subframe
  - For non-hopping PUSCH:
    - ([log₂(N_{RB}^{UL}(N_{RB}^{UL} +1)/2)]) bits provide the resource allocation in the UL subframe
- Modulation and coding scheme and redundancy version - 5 bits
- New data indicator - 1 bit
- TPC command for scheduled PUSCH - 2 bits
- Cyclic shift for DM RS - 3 bits
- UL index - 2 bits (this field is present only for TDD operation with uplink-downlink configuration 0)
- Downlink Assignment Index (DAI) - 2 bits (this field is present only for TDD operation with uplink-
  downlink configurations 1-6)
- CQI request - 1 bit
- Carrier Index Field (CIF) - 3 bits(this field is present only for Carrier Aggregation)
```

In Table 9, a new data indicator (NDI), having 1 bit, indicates whether or not a corresponding uplink grant is for a transmission of new data or a retransmission of existing data. If the NDI is for a retransmission, the uplink grant allocates only resource for a retransmission of the existing data. In this case, the UE cannot report carrier maximum transmit power. Thus, in order for the UE to report the carrier maximum transmit power, the UE must use resource distributed for new uplink data. Namely, the NDI is required to indicate that the corresponding uplink grant is for a transmission of new data.

The UE calculates carrier maximum transmit power with respect to a set UL CC (S1605) and generates carrier maximum transmit power information (P_{cmax,c} Information) including a carrier maximum transmit power field regarding the UL CC (S1610). The carrier maximum transmit power information, a message of an upper layer, may be any one of a MAC PDU, an RLC (Radio Link Control) PDU, and an RRC message. When the carrier maximum transmit power information is a MAC PDU, the carrier maximum transmit power information may include the MAC control element illustrated in FIGS. 10 to 14.

The UE transmits the carrier maximum transmit power information to the BS through uplink resource allocated by the uplink grant (S1615).

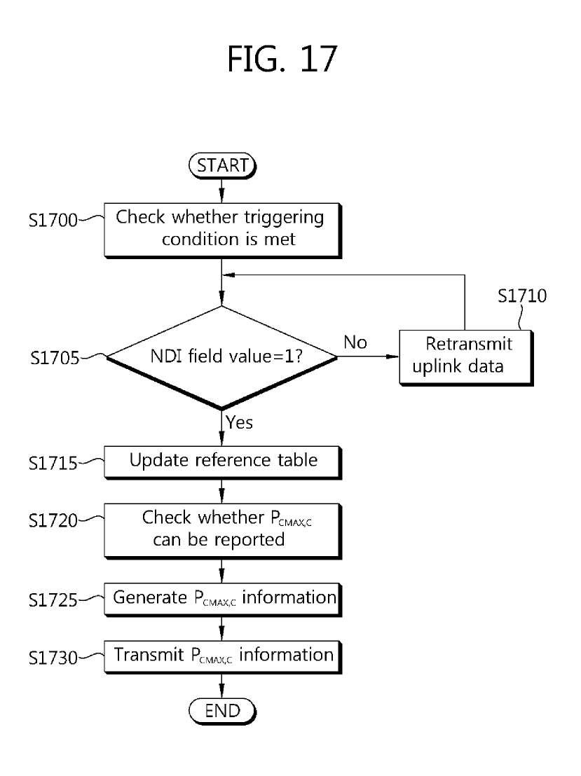

FIG. 17 is a flow chart illustrating a process of a method for reporting carrier maximum transmit power by a user equipment (UE) according to an embodiment of the present invention.

With reference to FIG. 17, the UE checks whether or not a triggering condition regarding reporting of carrier maximum transmit power is met (S1700). The triggering condition is that a CC whose variation (ΔP_{cmax,c}), i.e., the difference between power amount determined in the carrier maximum transmit power reference table (referred to as a ‘reference table’, hereinafter) and a carrier maximum transmit power amount, is greater than a threshold value, exists. The reference table is information regarding a carrier maximum transmission power amount previously shared by the UE and the BS based on the current component carrier combination and resource allocation (RB and MCS level). The reference table may be a default value determined in a standard according to a unique specification of the UE.

In order to determine whether or not the received uplink grant is for a transmission of uplink data, the UE checks whether or not the NDI field value included in the uplink grant is 1 (S1705). When the NDI field value is 1, the uplink grant is for a transmission of new data, and when it is 0, the uplink grant is for a retransmission of existing data.

When the NDI field value is 0, the UE checks uplink data to be retransmitted from an HARQ buffer, from information within an HARQ entity, and retransmits the uplink data to the BS (S1710).

When the NDI field value is 1, the UE updates the reference table with the calculated carrier maximum transmit power value (S1715). Here, the portion regarding the current component carrier combination and resource allocation in the reference table is updated. Step S1715 may include, for example, substeps as follows. An upper layer of the UE instructs a lower layer to calculate the carrier maximum transmit power. Thereafter, the lower layer calculates the carrier maximum transmit power and reports it to the upper layer. The upper layer stores the reported carrier maximum transmit power value in the HARQ buffer. The upper layer may be any one of L2 layers, namely, a MAC layer, an RLC layer, and an RRC layer, and the lower layer may be a physical layer or a MAC layer. The HARQ buffer is a buffer for storing the MAC PDU.

The UE checks whether or not the carrier maximum transmit power can be reported from the received uplink grant (S1720). Step S1720 may include, for example, substeps as follows. The UE checks uplink resource information within the received uplink grant and calculates the amount of transmittable resource within a corresponding subframe. Here, the UE checks whether or not the carrier maximum transmit power can be reported in the corresponding subframe in consideration of priority of a transmission of data currently stored in the uplink buffer, priority of a transmission of other MAC control element data, and priority of a carrier maximum transmit power report.

When the carrier maximum transmit power can be reported, the UE generates carrier maximum transmit power information (S1725). The carrier maximum transmit power information includes a carrier maximum transmit power field. The carrier maximum transmit power information may include such a MAC PDU or MAC control element as illustrated in FIGS. 10 to 14.

The UE transmits the carrier maximum transmit power information to the BS by using uplink resource indicated by the received uplink grant (S1730). The carrier maximum transmit power information may be transmitted along with different new uplink data.

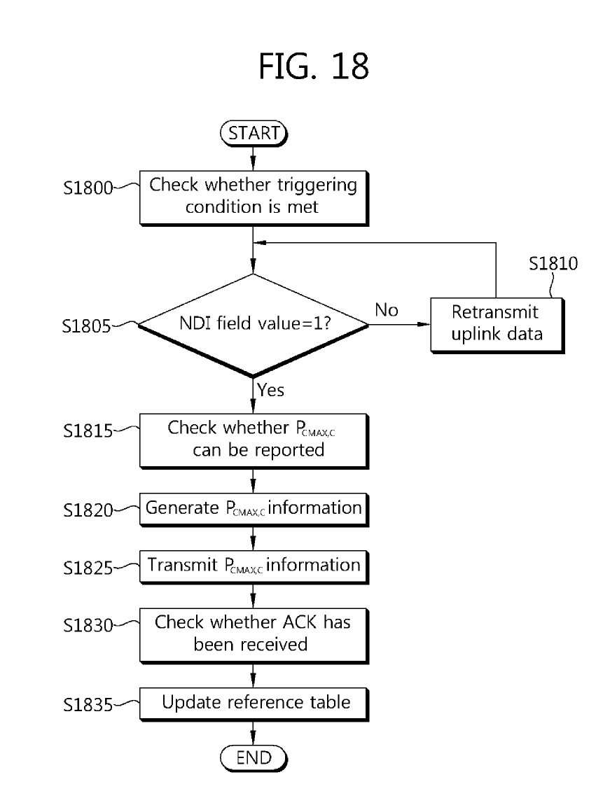

FIG. 18 is a flow chart illustrating a process of a method for performing reporting of a carrier maximum transmit power by UE according to another embodiment of the present invention. Unlike the case of FIG. 17, FIG. 18 features that updating of the reference table is performed under the condition that ACK indicating successful reception of the carrier maximum transmit power information is received from the BS.

With reference to FIG. 18, the UE checks whether or not a triggering condition regarding reporting of carrier maximum transmit power is met (S1800). The triggering condition is that a CC, whose variation (ΔP_{cmax,c}), i.e., the difference between power amount determined in the reference table and a carrier maximum transmit power amount, is greater than a threshold value, exists. This is the same as the procedure of step S1700.

In order to determine whether or not the received uplink grant is for a transmission of uplink data, the UE checks whether or not the NDI field value included in the uplink grant is 1 (S1805). This is the same as the procedure of step S1705.

When the NDI field value is 0, the UE checks uplink data to be retransmitted from an HARQ buffer, from information within an HARQ entity, and retransmits the uplink data to the BS (S1810). This is the same as the procedure of step S1710.

When the NDI field value is 1, the UE checks whether or not the carrier maximum transmit power can be reported from the received uplink grant (S1815). This is the same as the procedure of step S1720.

When the carrier maximum transmit power can be reported, the UE generates carrier maximum transmit power information (S1820). This is the same as step S1725.

The UE transmits the carrier maximum transmit power information to the BS by using uplink resource indicated by the received uplink grant (S1825). This is the same as the procedure of step S1730. The carrier maximum transmit power information may be transmitted along with different new uplink data.

The UE receives ACK indicating that the carrier maximum transmit power information has been successfully received, from the BS (S1830). If the BS has not successfully received the carrier maximum transmit power information, the carrier maximum transmit power may be required to be newly calculated. When the reference table is updated after confirming that the BS has successfully received the carrier maximum transmit power information, a degradation of performance due to unnecessary updating of the reference table can be prevented.

The UE updates the reference table with the current carrier maximum transmit power value (S1835). Here, the portion regarding the current component carrier combination and resource allocation in the reference table is updated. This is the same as step S1715.

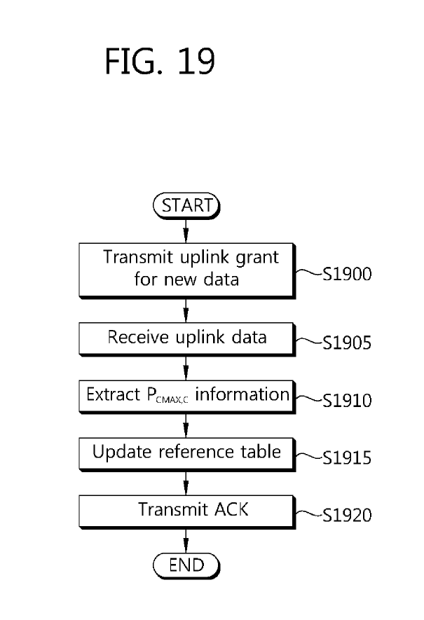

FIG. 19 is a flow chart illustrating a process of a method for receiving a report of a carrier maximum transmit power by a BS according to another embodiment of the present invention.

With reference to FIG. 19, the BS transmits an uplink grant to the UE (S1900). The uplink grant includes such an NDI as shown in Table 9. The BS sets the NDI based on the following reference. For example, the BS checks whether or not a message requesting uplink scheduling, such as a scheduling request, or the like, has been received from the UE. In another example, the BS checks whether or not the previously transmitted data has an error through a buffer state report value.

Based on such references, the BS may determine whether to configure the uplink grant for new data or whether to configure the uplink grant for a retransmission. Here, in order for the UE to recognize whether or not the uplink grant is for a transmission of new data, the BS sets a new data indicator field value. When the BS configures the uplink grant for new data, the BS sets the new data indicator field value as 1 and when the BS configures the uplink grant for a retransmission, the BS sets the new data indicator field value as 0.

The BS receives uplink data from the UE (S1905). When the BS has transmitted an uplink grant for new data to the UE, the BS checks whether or not the uplink data includes carrier maximum transmit power information. When the uplink data is a MAC PDU, the BS may check whether or not the uplink data includes carrier maximum transmit power information by using an LCID field value within a MAC subheader.

When the uplink data includes the carrier maximum transmit power information, the BS extracts the carrier maximum transmit power information (S1910), interprets the carrier maximum transmit power field, and updates the information of the reference table (S1915). In this case, the BS stores the updated reference table in UE context.

When the BS successfully receives and extracts the carrier maximum transmit power information, the BS transmits ACK to the UE (S1920).

4. Maximum Transmit Power Reporting Apparatus and Receiving Apparatus

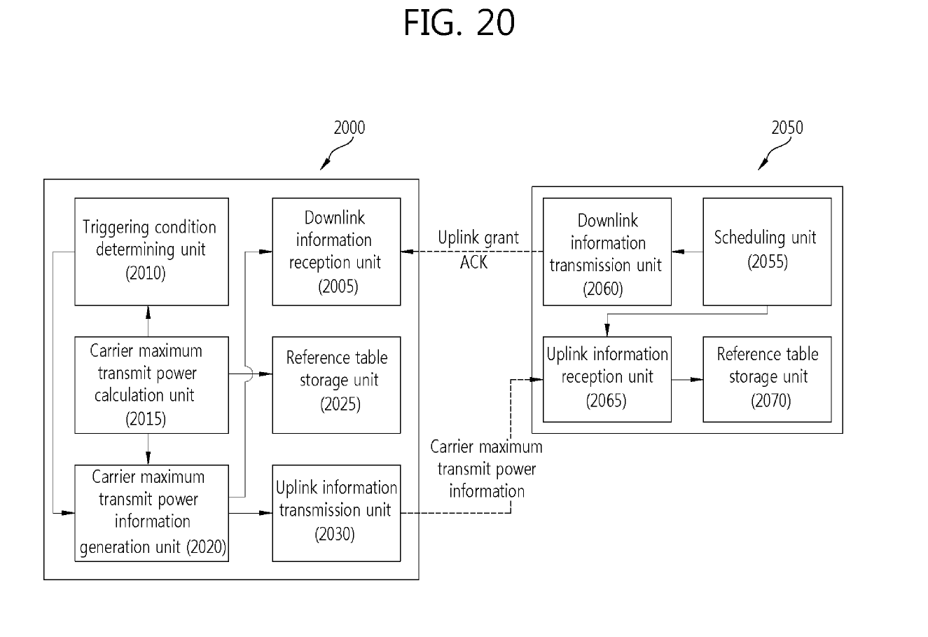

FIG. 20 is a block diagram of a UE reporting carrier maximum transmit power and a BS receiving the report according to an embodiment of the present invention.

With reference to FIG. 20, a UE includes a downlink information reception unit 2005, a triggering condition determining unit 2010, a carrier maximum transmit power calculation unit 2015, a carrier maximum transmit power information generation unit 2020, a reference table storage unit 2025, and an uplink information transmission unit 2030.

The downlink information reception unit 2005 receives an uplink grant from a BS 2050. Table 9 shows an example of the uplink grant. Also, the downlink information reception unit 2005 receives ACK indicating that the carrier maximum transmit power information has been successfully received, from the BS 2050.

The triggering condition determining unit 2010 determines whether or not a triggering condition is met. The triggering condition is that a CC whose variation (ΔP_{cmax,c}), i.e., the difference between power amount determined in the reference table and a current carrier maximum transmit power amount, is greater than a threshold value, exists.

The carrier maximum transmit power calculation unit 2015 calculates carrier maximum transmit power of each CC. Each CC may be set in the UE 2000. Or, each CC may be set in the UE 2000 and activated. Or, each CC may be a UL PCC and/or a UL SCC. The carrier maximum transmit power calculation unit 2015 informs the carrier maximum transmit power information generation unit 2020 about the calculated carrier maximum transmit power of each CC.

The carrier maximum transmit power information generation unit 2020 checks whether or not the carrier maximum transmit power information can be inserted in new data if the uplink grant is for a transmission of new data. If the carrier maximum transmit power information can be inserted, the carrier maximum transmit power information generation unit 2020 generates carrier maximum transmit power information. How the carrier maximum transmit power information generation unit 2020 generates the carrier maximum transmit power information has been described in detail in subject 1 and 2 above.

When the triggering condition is met, the reference table storage unit 2025 updates the reference table by reflecting the carrier maximum transmit power amount in the reference table.

The uplink information transmission unit 2030 transmits the generated carrier maximum transmit power information by using uplink resource indicated by the uplink grant.

The BS 2050 includes a scheduling unit 2055, a downlink information transmission unit 2060, an uplink information reception unit 2065, and a reference table storage unit 2070.

The scheduling unit 2055 performs uplink scheduling. The uplink scheduling refers to determining uplink resource required for the UE 2000 to perform an uplink transmission, and uplink parameters such as MCS, RV (redundancy version), or the like. An uplink grant is configured as a result of uplink scheduling.

The downlink information transmission unit 2060 transmits the uplink grant configured by the scheduling unit 2055, as a message to the UE 2000. Also, the downlink information transmission unit 2060 may transmit ACK indicating that carrier maximum transmit power information has been successfully detected from power information received from the UE 2000, to the UE 2000.

The uplink information reception unit 2065 receives carrier maximum transmit power information from the UE 2000.

The reference table storage unit 2070 learns (recognizes or obtains) a carrier maximum transmit power value of each CC from the power information, and reflects the carrier maximum transmit power values in the existing reference table, thus updating the reference table.

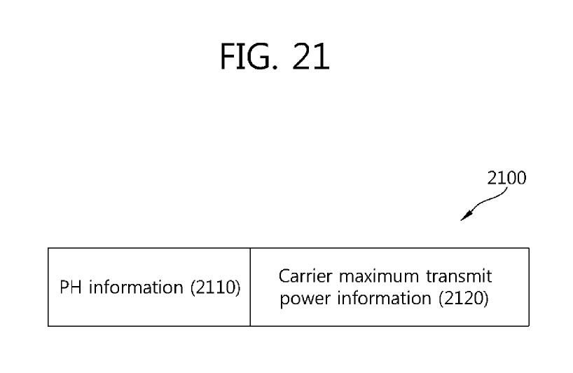

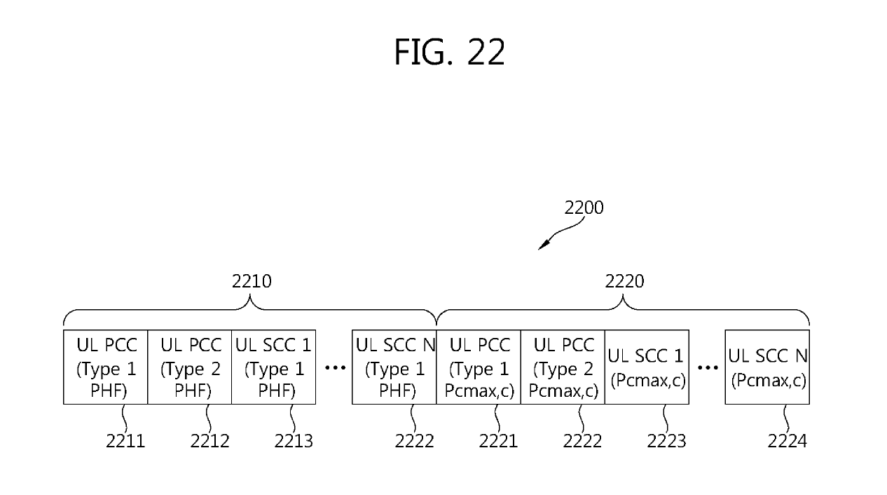

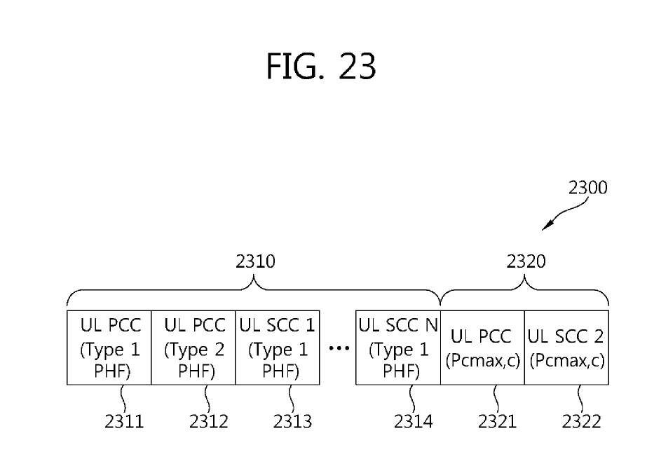

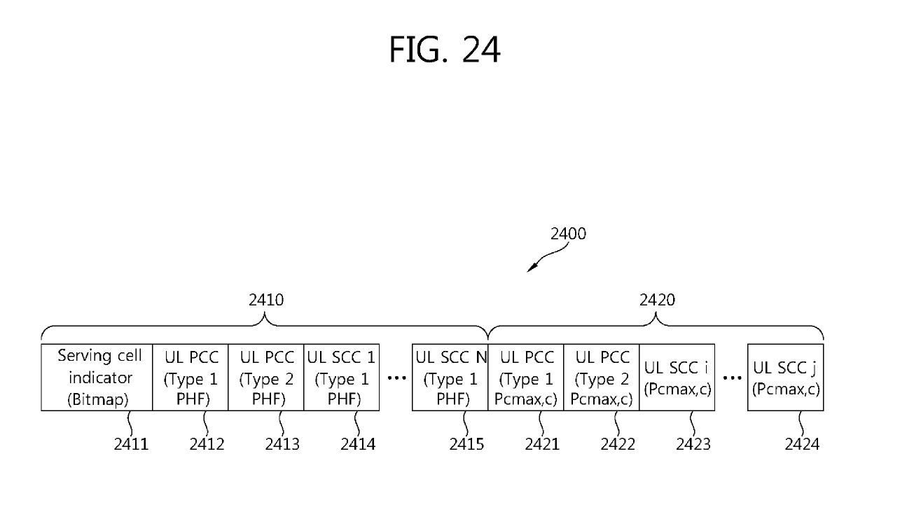

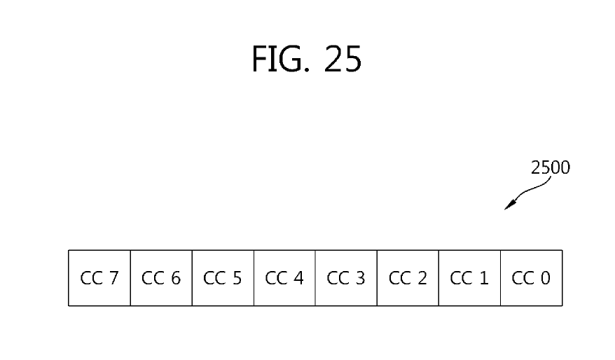

FIGS. 21 to 25 illustrates the MAC control element for a power report in detail. The MAC control element for a power report includes PH information and the carrier maximum transmit power information described above with reference to FIGS. 11 and 12. In particular, FIGS. 22 and 23 show embodiments in which the MAC control element for a power report does not include a serving cell indicator, and FIGS. 24 and 25 show embodiments in which the MAC control element for a power report includes a serving cell indicator. The serving cell indictor is information indicating a carrier as a target of a PH report.

In either case, the method of configuring a carrier maximum transmit power field with respect to a UL PCC of a primary serving cell is applied in the same manner to every MAC control element structure. For example, in case in which the UE is set to a mode in which a PUCCH and a PUSCH can be simultaneously transmitted in parallel, when at least one of the carrier maximum transmit power values of Type 1 and Type 2 has been changed by more than a threshold value, reporting of the carrier maximum transmit power of Type 1 and that of Type 2 are simultaneously made. The threshold value may be expressed by a value such as 2 dBm, 3 dBm, or 5 dBm. Also, the threshold value of the carrier maximum transmit power values of Type 1 and Type 2 may be set to be different or may be set to be equal. Meanwhile, when the UE is set to a mode in which a PUCCH and a PUSCH cannot be simultaneously transmitted, only the carrier maximum transmit power value of Type 1 is considered. Namely, when the carrier maximum transmit power value of Type 1 has been changed by more than the threshold value, only the carrier maximum transmit power of Type 1 is reported.

FIG. 21 is a view showing the structure of a MAC control element for reporting power according to an embodiment of the present invention.

With reference to FIG. 21, the MAC control element 2100 for a power report includes PH information 2110 and carrier maximum transmit power information 2120.

The PH information 2110 includes at least one PH field and a relevant first supplementary field. Each PH field indicates a PH value with respect to a particular single CC. The first supplementary field may be a serving cell indicator field indicating to which CC each PH field value is related.

The carrier maximum transmit power information 2120 includes at least one carrier maximum transmit power field and a relevant second supplementary field. Each carrier maximum transmit power field indicates a carrier maximum transmit power value with respect to a particular single CC among CCs whose PH value is transmitted or to be transmitted to the BS. The second supplementary field may be a cell index field indicating to which CC the value of each carrier maximum transmit power field is related. Or, the second supplementary field may be a type indication field indicating whether maximum transmit power regarding a UL PCC is Type 1 or Type 2.

A transmission of the MAC control element for a power report may be triggered in the following case. For example, each information may be transmitted to the BS according to an independent triggering condition for transmitting the PH information or the carrier maximum transmit power information. IN this case, the MAC control element for a power report may include only any one of the PH information and the carrier maximum transmit power information.

In another example, when a triggering condition regarding any one of them is met, the PH information and the carrier maximum transmit power information of each CC may be simultaneously transmitted. In this case, the MAC control element for a power report may include both of the PH information and the carrier maximum transmit power information.

In another example, when the triggering condition regarding every information is met, the PH information and the carrier maximum transmit power information of each CC may be simultaneously transmitted. For example, in case in which a triggering condition for transmitting PH information occurs, when carrier maximum transmit power of a particular CC among CCs to be reported to the BS with respect to a subframe whose PH should be measured has been changed by more than a threshold value, the UE may configure the PH information and the carrier maximum transmit power information of each CC as a single MAC control element, and transmit the same to the BS.

FIG. 22 is a view showing the structure of a MAC control element for reporting power according to another embodiment of the present invention.

With reference to FIG. 22, a MAC control element 2200 for a power report includes PH information 2210 and carrier maximum transmit power information 2220 with respect to UL CCs of every serving cell.

Namely, the PH information 2210 includes a Type 1 PHF 2211 with respect to a UL PCC, a Type 2 PHF 2212 with respect to a UL PCC, a PHF 2213 with respect to UL SCC1, . . . , and a PHF 2214 with respect to a UL SCC N. The UE and the BS already know which serving cells are activated or in which serving cell among the activated serving cells a UL CC is configured, so the PH information 2210 is not required to include a serving cell indicator indicating to which CC each PHF is related. In this case, the PHFs are required to be disposed in order of CCs. The order must be previously agreed between the UE and the BS.

Similarly, the carrier maximum transmit power information 2220 includes Type 1 carrier maximum transmit power field with respect to a UL PCC (Type 1 P_{cmax,c}) 2221, Type 2 carrier maximum transmit power field with respect to a UL PCC (Type 2 P_{cmax,c}) 2222, a carrier maximum transmit power field with respect to a UL SCC1 2223, . . . , and a carrier maximum transmit power field with respect to a UL SCC N 2224. In this case, there is no need to include a cell index field indicating to which CC each carrier maximum transmit power field is related. Thus, the carrier maximum transmit power information 2220 is configured in the form of octet as illustrated in FIG. 11. In this case, the carrier maximum transmit power fields are required to be disposed in order of matched CCs. The order must be previously agreed between the UE and the BS.

FIG. 23 is a view showing the structure of a MAC control element for reporting power according to another embodiment of the present invention.

With reference to FIG. 23, a MAC control element 2300 for a power report includes PH information 2310 with respect to UL CCs of every serving cell and carrier maximum transmit power information 2320 with respect to UL CCs of some activated serving cells.

Namely, the PH information 2310 includes a Type 1 PHF 2311 with respect to a UL PCC, a Type 2 PHF 2312 with respect to a UL PCC, a PHF 2313 with respect to UL SCC1, . . . , a PHF 2314 with respect to a UL SCC N. The UE and the BS already know which serving cells are activated or in which serving cell among the activated serving cells a UL CC is configured, so the PH information 2310 is not required to include a serving cell indicator indicating to which CC each PHF is related. In this case, the PHFs are required to be disposed in order of CCs. The order must be previously agreed between the UE and the BS.

Meanwhile, the carrier maximum transmit power information 2320 includes only the carrier maximum transmit power field 2321 with respect to UL PCC and a carrier maximum transmit power field 2322 with respect to UL SCC2. The BS cannot know maximum transmit power related to which of UL CCs is reported. Thus, the carrier maximum transmit power information 2320 should include a type indication field and a cell index field (not shown), besides the carrier maximum transmit power field. Thus, the carrier maximum transmit power information 2320 has a structure including all of the type indication field, the cell index field, and the carrier maximum transmit power field as shown in FIG. 12.

FIG. 24 is a view showing the structure of a MAC control element for reporting power according to another embodiment of the present invention. In this case, the MAC control element for a power report includes a serving cell indicator. The structure of the MAC control element of FIG. 24 is a structure in which a carrier maximum transmit power report is triggered only for a CC whose PH report is triggered.

With reference to FIG. 24, the MAC control element 2400 for a power report includes PH information 2410 with respect to a UL CC of at least one first serving cell and a carrier maximum transmit power information 2420 with respect to a UL CC of at least one second serving cell.

The PH information 2410 includes a serving cell indicator 2411 indicating the at least one first serving cell and one or more PHFs 2412, 2413, 2414, and 2415.

The serving cell indicator 2411 may have such an octet structure as shown in FIG. 25. With reference to FIG. 25, a serving cell indicator 2500 having an octet structure is a bit map comprised of 8 bits. A CC is mapped to each bit, and CCs are mapped in order of CC7, CC6, CC5, . . . , CC0, starting from the left. Here, CC0 indicates a primary serving cell all the time, and CC1 to CC7 follow the serving cell index of the secondary serving cell. When the value of a bit is 1, it indicates that the PH field with respect to the UL CC of the corresponding serving cell is included in the MAC control element. Here, in case in which a bit value at the CC0 position is 1, only when the UE is set to the mode (Type 2) in which the PUSCH and the PUCCH are simultaneously transmitted through the primary serving cell, the bit value 1 indicates that the PH fields with respect to Type 1 and Type 2 for the UL CC of the primary serving cell are all included in the MAC control element. When the UE is not set to the foregoing mode, only the PH field with respect to Type 1 for the UL CC of the primary serving cell is included in the MAC control element for a power report.

With reference back to FIG. 24, the first PHF 2412 indicates PH of Type 1. The second PHF 2413 indicates PH of Type 2. The third PHF 2414 and the fourth PHF 2415 indicate PH with respect to a UL CC of each secondary serving cell.

The carrier maximum transmit power information 2420 includes one or more carrier maximum transmit power fields 2421, 2422, 2423, and 2424. The one or more carrier maximum transmit power fields 2421, 2422, 2423, and 2424 are related to CCs to which carrier maximum transmit power report is triggered, among CCs to which PHR is triggered. For example, when CCs to which the PHR is triggered are CC0, CC1, CC2, and CC3, if the carrier maximum transmit power report is triggered only to CC2 and CC3, among CC0, CC1, CC2, and CC3, the carrier maximum transmit power information 2420 includes only carrier maximum transmit power fields with respect to CC2 and CC2.

In FIG. 24, a first carrier maximum transmit power field 2421 indicates carrier maximum transmit power with respect to the UL PCC of Type 1, a second carrier maximum transmit power field 2422 indicates carrier maximum transmit power with respect to the UL PCC of Type 2, and a third carrier maximum transmit power field 2423 and a fourth carrier maximum transmit power field 2424 indicates carrier maximum transmit power with respect to the UL SCCi and UL PCCj, respectively.

In this case, when only the carrier maximum transmit power report with respect to some CCs is made, the BS should be able to know to which CCs the carrier maximum transmit power report is related. Thus, the UE configures a carrier maximum transmit power information 2420 having such a structure (i.e., the structure including a cell index field) as shown in FIG. 12.

Meanwhile, when the carrier maximum transmit power report is triggered to all of the CCs, the BS can know to which CCs the respective carrier maximum transmit power fields are related, even without a cell index field. For example, when the order of the carrier maximum transmit power fields are determined in an index ascending order or descending order or a particular order of CCs, the UE disposes the carrier maximum transmit power fields in the order. And, the BS can map the respective carrier maximum transmit power fields to the CCs in the order. In this case, the carrier maximum transmit power information 2420 may have a structure including only the carrier maximum transmit power field as shown in FIG. 1.

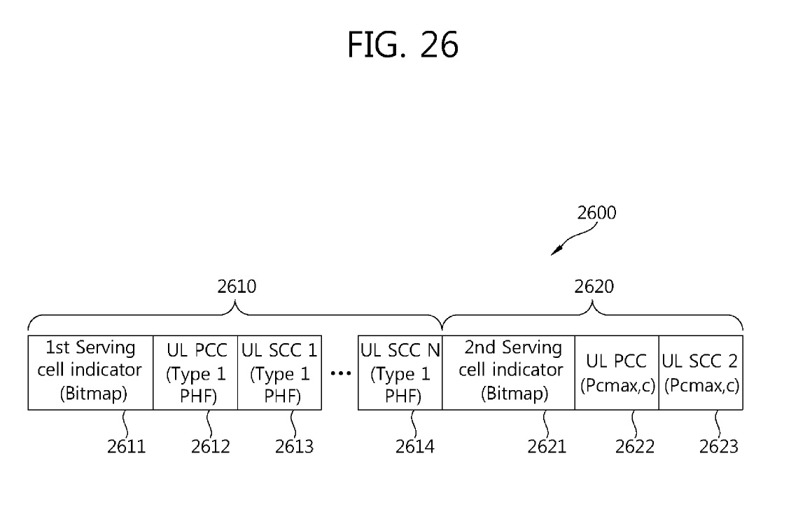

FIG. 26 is a view showing the structure of a MAC control element for reporting power according to another embodiment of the present invention. The MAC control element for a power report includes a first serving cell indicator indicating a CC as a target of a PHR and a second serving cell indicator indicating a CC as a target of a carrier maximum transmit power report. The structure of MAC control element of FIG. 26 is a structure in which the carrier maximum transmit power report is triggered only to CCs to which the PHR is triggered.

With reference to FIG. 26, a MAC control element 2600 for a power report includes PH information 2610 with respect to a UL CC of at least one first serving cell and carrier maximum transmit power information 2620 with respect to a UL CC of at least one second serving cell.

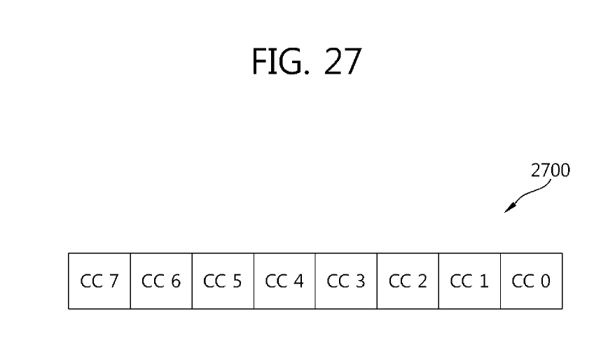

The carrier maximum transmit power information 2620 includes a second serving cell indicator 2621. The second serving cell indicator 2621 indicates a CC to which the carrier maximum transmit power report is triggered, among CCs indicated by the first serving cell indicator 2611. The second serving cell indicator 2621 may have a bitmap structure 1700 as shown in FIG. 27. With reference to FIG. 19, a CC is mapped to each bit, and CCs are mapped in order of CC7, CC6, CC5, . . . , CC0, starting from the left. Here, CC0 indicates a primary serving cell all the time, and CC1 to CC7 follow the serving cell index of the secondary serving cell. When the value of a bit is 1, it indicates that the PH field with respect to the UL CC of the corresponding serving cell is included in the MAC control element. Here, in case in which a bit value at the CC0 position is 1, only when the UE is set to the mode (Type 2) in which the PUCCH and the PUCCH are simultaneously transmitted through the primary serving cell, the bit value 1 indicates that the PH fields with respect to Type 1 and Type 2 for the UL CC of the primary serving cell are all included in the MAC control element. When the UE is not set to the foregoing mode, only the PH field with respect to Type 1 for the UL CC of the primary serving cell is included in the MAC control element for a power report.

With reference back to FIG. 26, CCs indicated by the first serving cell indicator 2611 are those to which PHR is triggered. As described above, the condition under which the carrier maximum transmit power report is triggered is when the carrier maximum transmit power amount with respect to a corresponding CC is changed by more than a threshold value. In FIG. 26, CCs indicated by the second serving cell indicator 2621 are UL PCC and UL SCC2. Here, the carrier maximum transmit power information 2620 has a structure including only the carrier maximum transmit power field as shown in FIG. 11.

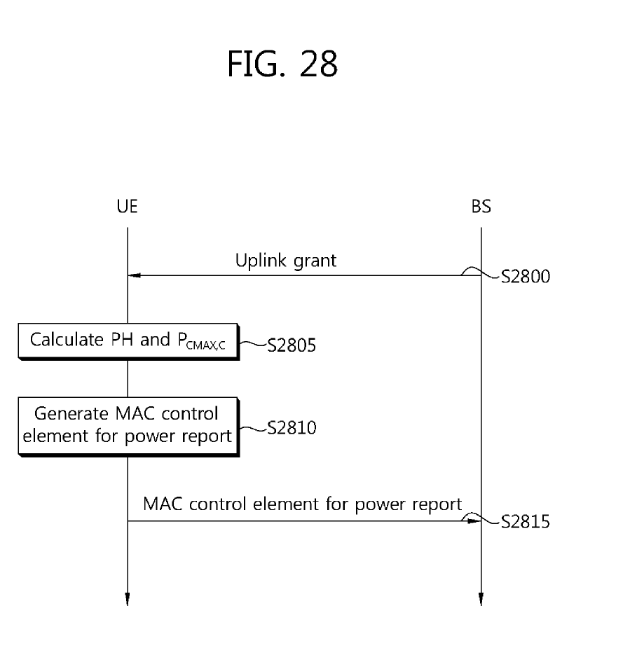

FIG. 28 is a flow chart illustrating a method for reporting power according to an embodiment of the present invention.

With reference to FIG. 28, the BS transmits an uplink grant to the UE (S2800). The uplink grant is information corresponding to a format 0 of downlink control information (DCI) transmitted via a PDCCH, which includes information regarding RB, MCS,'TPC, or the like. Table 10 shows an example of the upper grant.

```
TABLE 10
- Flag for format0/format1A differentiation - 1 bit, where value 0 indicates format 0 and value 1 indicates
  format 1A
- Frequency hopping flag - 1 bit
- Resource block assignment and hopping resource allocation- [log₂(N_{RB}^{UL}(N_{RB}^{UL} +1)/2)] bits
  - For PUSCH hopping:
    - N_{UL}_hop MSB bits are used to obtain the value of ñ_{PRB}(i)
    - ([log₂(N_{RB}^{UL}(N_{RB}^{UL} +1)/2)] − N_{UL}_hop) bits provide the resource allocation of the first slot in the
    UL subframe
  - For non-hopping PUSCH:
    - ([log₂(N_{RB}^{UL}(N_{RB}^{UL} +1)/2)]) bits provide the resource allocation in the UL subframe
- Modulation and coding scheme and redundancy version - 5 bits
- New data indicator - 1 bit
- TPC command for scheduled PUSCH - 2 bits
- Cyclic shift for DM RS - 3 bits
- UL index - 2 bits (this field is present only for TDD operation with uplink-downlink configuration 0)
- Downlink Assignment Index (DAI) - 2 bits (this field is present only for TDD operation with uplink-
  downlink configurations 1-6)
- CQI request - 1 bit
- Carrier Index Field (CIF) - 3 bits(this field is present only for Carrier Aggregation)
```

In Table 10, the new data indicator (NDI), having 1 bit, indicates whether or not a corresponding uplink grant is for a transmission of new data or a retransmission of existing data. If the NDI is for a retransmission, the uplink grant allocates only resource for a retransmission of the existing data. In this case, the UE cannot report carrier maximum transmit power. Thus, in order for the UE to report the carrier maximum transmit power, the UE must use resource distributed for new uplink data. Namely, the NDI is required to indicate that the corresponding uplink grant is for a transmission of new data.

The UE calculates PH of each of CCS of a first set to which PHR is triggered, and calculates a carrier maximum transmit power of each of the CCs of a second set to which the carrier maximum transmit power report is triggered among the CCs belonging to the first set (S2805).

The UE generates a MAC control element for a power report including the PH field with respect to the CCs of the first set and the carrier maximum transmit power field with respect to the CCs of the second set (S2810). The MAC control element for the power report is a message of an upper layer, which may be any one of a MAC PDU, an RLC (Radio Link Control) PDU, and an RRC.

The UE transmits the MAC control element for the power report to the BS through uplink resource allocated by the uplink grant (S2815).

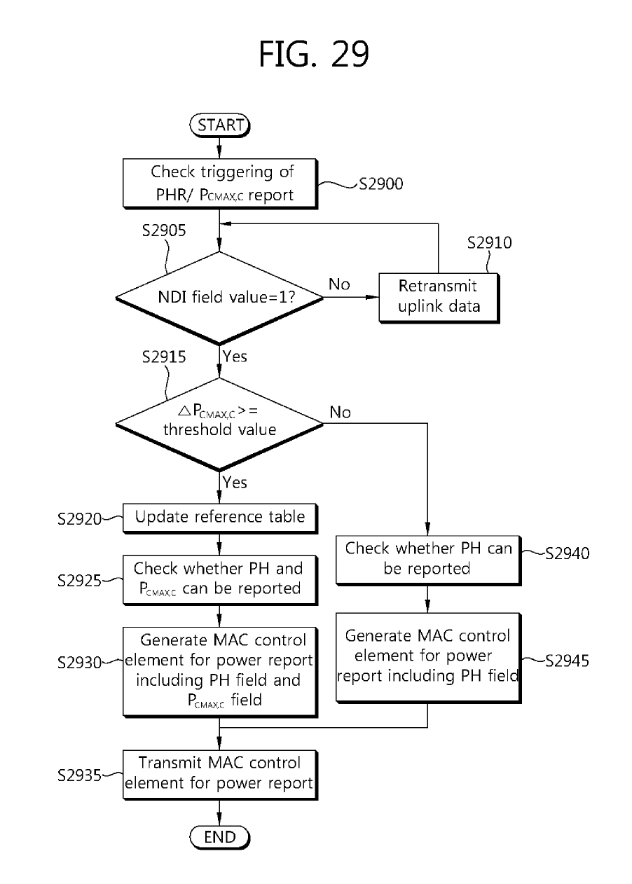

FIG. 29 is a flow chart illustrating a process of a method for performing reporting of power by a UE according to an embodiment of the present invention.

With reference to FIG. 29, the UE calculates PH and carrier maximum transmit power and checks whether or not a first triggering condition regarding a PH report and a second triggering condition regarding a carrier maximum transmit power report are met based on the calculated PH and carrier maximum transmit power (S2900). The calculation of PH is performed limitedly on UL CCs set in the UE among the UL CCs of the activated serving cell. In this case, the UE may configure a first serving cell indicator indicating the limited UL CCs.

The second triggering condition is that a CC whose variation (ΔP_{cmax,c}), i.e., the difference between power amount determined in the carrier maximum transmit power reference table (referred to as a ‘reference table’, hereinafter) and a carrier maximum transmit power amount, is greater than a threshold value exists. The reference table is information regarding a carrier maximum transmission power amount previously shared by the UE and the BS based on the current component carrier combination and resource allocation (RB and MCS level). The reference table may be a default value determined in a standard according to a unique specification of the UE.

In order to determine whether or not the received uplink grant is for a transmission of uplink data, the UE checks whether or not the NDI field value included in the uplink grant is 1 (S2905). When the NDI field value is 1, the uplink grant is for a transmission of new data, and when it is 0, the uplink grant is for a retransmission of existing data.

When the NDI field value is 0, the UE checks uplink data to be retransmitted from an HARQ buffer, from information within an HARQ entity, and retransmits the uplink data to the BS (S2910).

When the NDI field value is 1, the UE determines whether or not a variation of the carrier maximum transmit power value is greater than a threshold value (S2915).

When the variation of the carrier maximum transmit value is greater than a threshold value, the UE updates the reference table with the current carrier maximum transmit power value (S2920). Here, the portion regarding the current component carrier combination and resource allocation in the reference table is updated. Step S2920 may includes following substeps. An upper layer of the UE instructs a lower layer to calculate the carrier maximum transmit power. Thereafter, the lower layer calculates the carrier maximum transmit power and reports it to the upper layer. The upper layer stores the reported carrier maximum transmit power value in the HARQ buffer. The upper layer may be any one of L2 layers, namely, a MAC layer, an RLC layer, and an RRC layer, and the lower layer may be a physical layer or a MAC layer. The HARQ buffer is a buffer for storing the MAC PDU.

The UE checks whether or not the PH and the carrier maximum transmit power can be reported through a MAC control element for a single power report from the received uplink grant (S2925). Step S2925 may be fragmented as follows. The UE checks uplink resource information within the received uplink grant and calculates the amount of transmittable resource within a corresponding subframe. Here, the UE checks whether or not the carrier maximum transmit power can be reported in the corresponding subframe in consideration of priority of a transmission of data currently stored in the uplink buffer, priority of a transmission of other MAC control element data, and priority of a carrier maximum transmit power report.

When the PH and the carrier maximum transmit power can be reported together, the UE generates a MAC control element for a power report including at least one PH field and at least one carrier maximum transmit power field (S2930).

Here, the MAC control element may be used to indicate an PH report and is transmitted in the form of a MAC message which includes a first subheader including an LCID field that indicates a transmission of P_{cmax.c} or a second subheader including the LCID field that indicates a transmission of the PH and P_{cmax.c}.

The UE transmits the MAC control element for the power report by using uplink resource indicated by the received uplink grant (S2935). The MAC control element for the power report may be transmitted together with different new uplink data.

In step S2915, when the variation of the carrier maximum transmit power value is not greater than the threshold value, since the second triggering condition is not met, the UE does not report the carrier maximum transmit power. Instead, the UE may report only the triggered PH. Thus, the UE checks whether or not the PH can be reported (S2940). Thereafter, the UE generates a MAC control element for a power report including a PH field (S2945), and transmits the MAC control element for the power report to the BS (S2935).

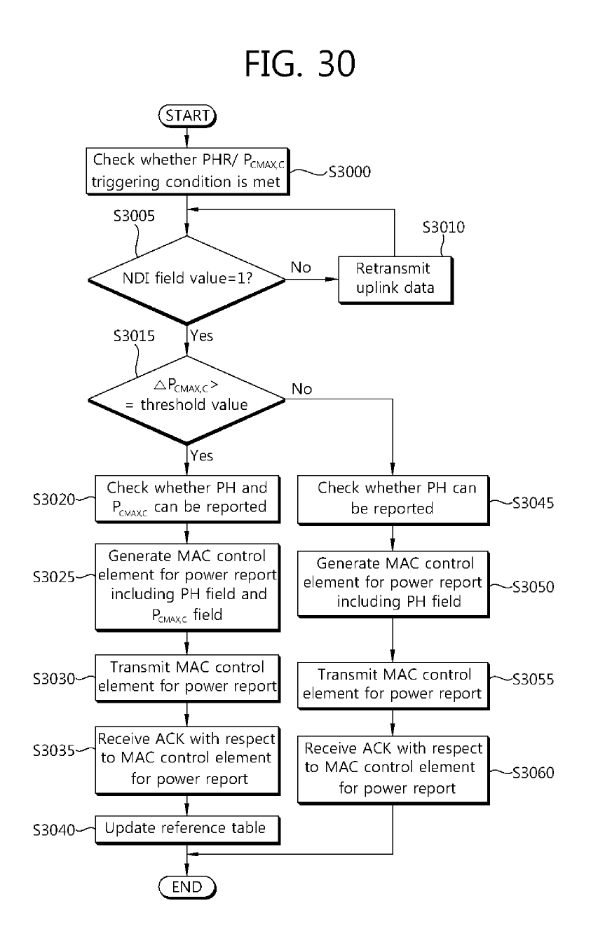

FIG. 30 is a flow chart illustrating a process of a method for performing reporting of power by the UE according to another embodiment of the present invention. Unlike the case of FIG. 29, FIG. 30 features that updating of the reference table is performed under the condition that ACK indicating successful reception of the carrier maximum transmit power information is received from the BS.

With reference to FIG. 30, the UE calculates PH and carrier maximum transmit power and checks whether or not a first triggering condition regarding a PH report and a second triggering condition regarding a carrier maximum transmit power report are met based on the calculated PH and carrier maximum transmit power (S3000). The calculation of PH is performed limitedly on UL CCs set in the UE among the UL CCs of the activated serving cell. In this case, the UE may configure a first serving cell indicator indicating the limited UL CCs. This is the same as the procedure of step S2900.

In order to determine whether or not the received uplink grant is for a transmission of new uplink data, the UE checks a new data indicator (NDI) field value included in the uplink grant (S3005). This is the same as the procedure of step S2905.

When the NDI field value is 0, the UE checks uplink data to be retransmitted from the HARQ buffer, from information within the HARQ entity, and retransmits the uplink data to the BS (S3010). This is the same as the procedure of step S2910.

When the NDI field value is 1, the UE determines whether or not a variation of the carrier maximum transmit power value is greater than a threshold value (S3015).

The UE checks whether or not the PH and the carrier maximum transmit power can be reported through a MAC control element for a single power report from the received uplink grant (S3020). This is the same as the procedure of step S2925.

When the PH and the carrier maximum transmit power can be reported together, the UE generates a MAC control element for a power report including at least one PH field and at least one carrier maximum transmit power field (S3025).

The UE transmits the MAC control element for the power report by using uplink resource indicated by the received uplink grant (S3030). The MAC control element for the power report may be transmitted together with different new uplink data. Here, the MAC control element may be used to indicate an PH report and is transmitted in the form of a MAC message additionally including a subheader including an LCID field that signifies a transmission of P_{cmax.c} or a subheader including the LCID field indicating a transmission of power information of each uplink component carrier that signifies reporting of the PH and P_{cmax.c}.

The UE receives ACK indicating that the BS has successfully received the MAC control element for the power report, from the BS (S3035). If the BS has not successfully received the carrier maximum transmit power information, the carrier maximum transmit power may be required to be newly calculated. When the reference table is updated after confirming that the BS has successfully received the carrier maximum transmit power information, a degradation of performance due to unnecessary updating of the reference table can be prevented.

The UE updates the reference table with the current carrier maximum transmit power value (S3040). This is the same as the procedure of step S2920.

In step S3015, when the variation of the carrier maximum transmit power value is not greater than the threshold value, since the second triggering condition is not met, the UE does not report the carrier maximum transmit power. Instead, the UE may report only the triggered PH. Thus, the UE checks whether or not the PH can be reported (S3045). Thereafter, the UE generates a MAC control element for a power report including a PH field (S3050), and transmits the MAC control element for the power report to the BS (S3055). Thereafter, the UE receives ACK indicating that the BS has successfully received the MAC control element, from the BS (S3060).

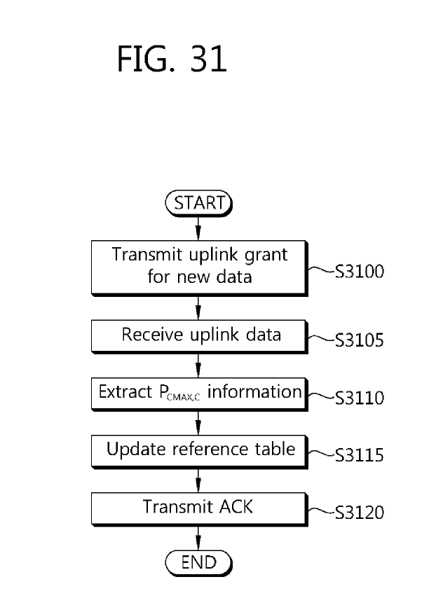

FIG. 31 is a flow chart illustrating a process of method for receiving a report of power by a BS according to an embodiment of the present invention.

With reference to FIG. 31, the BS transmits an uplink grant to the UE (S3100).

The uplink grant includes the NDI as shown in Table 9.

The BS sets the NDI based on the following reference. For example, the BS checks whether or not a message requesting uplink scheduling, such as a scheduling request, or the like, has been received from the UE. In another example, the BS checks whether or not the previously transmitted data has an error through a buffer state report value.

Based on such references, the BS may determine whether to configure the uplink grant for new data or whether to configure the uplink grant for a retransmission. Here, in order for the UE to recognize whether or not the uplink grant is for a transmission of new data, the BS sets a new data indicator field value. When the BS configures the uplink grant for new data, the BS sets the new data indicator field value as 1 and when the BS configures the uplink grant for a retransmission, the BS sets the new data indicator field value as 0.

The BS receives uplink data (S3105). When the BS has transmitted an uplink grant for new data to the UE, the BS checks whether or not the uplink data includes a MAC PDU. The MAC PDU includes a MAC subheader and a MAC control element. The BS may check whether or not the MAC control element is a MAC control element for reporting power by using an LCID field value within the MAC subheader. Here, the MAC control element may be used to indicate an PH report and is transmitted in the form of a MAC message additionally including a subheader including an LCID field that signifies a transmission of P_{cmax.c} or a subheader including the LCID field indicating a transmission of power information of each uplink component carrier that signifies reporting of the PH and P_{cmax.c}.

It is assumed that the MAC control element for reporting power includes both a PH field and a carrier maximum transmit power field. In this case, the BS may determine whether or not the MAC control element includes the carrier maximum transmit power field in consideration of the value of the L field and the PH field value within the MAC subheader. The L field indicates the length of the MAC control element by byte. For example, it is assumed that the value of the L field is 7, so a total Length 7 exists and a first serving cell indicator indicates three CCs. The first serving cell indicator (indicating PH report target CC) takes Length 1, and the BS may check the presence of three PH fields with respect to three CCs. Thus, Length 3 remains for reporting carrier maximum transmit power.

In this case, the BS may determine the number of the carrier maximum transmit power fields as follows. For example, when a second serving cell indicator (indicating a carrier maximum transmit power report target CC) exists, since the second serving cell indicator takes Length 1, the other remaining Length 2 is used as a carrier maximum transmit power field. In this case, according to Embodiment 1 and Embodiment 3 in FIG. 11, TWO carrier maximum transmit power fields may exist per Length. Thus, a maximum of two carrier maximum transmit power fields may exist over Length 2.

In another example, when the second serving indicator does not exist, Length 3 may be all used as the carrier maximum transmit power field. In this case, according to Embodiment 1 and Embodiment 3 in FIG. 11, a maximum of six carrier maximum transmit power fields may exist over Length 3. Meanwhile, according to Embodiment 2, Embodiment 4, and Embodiment 5 in FIG. 11 and Embodiment 1 and Embodiment 2 in FIG. 12, a maximum of three carrier maximum transmit power fields may exist over Length 3.

When the uplink data includes the MAC control element for reporting power, the BS extracts the MAC control element for reporting power (S3110), interprets the carrier maximum transmit power field, and updates the information of the reference table (S3115). In this case, the BS stores the updated reference table in UE context.

When the BS successfully receives and extracts the carrier maximum transmit power information, the BS transmits ACK to the UE (S3120).

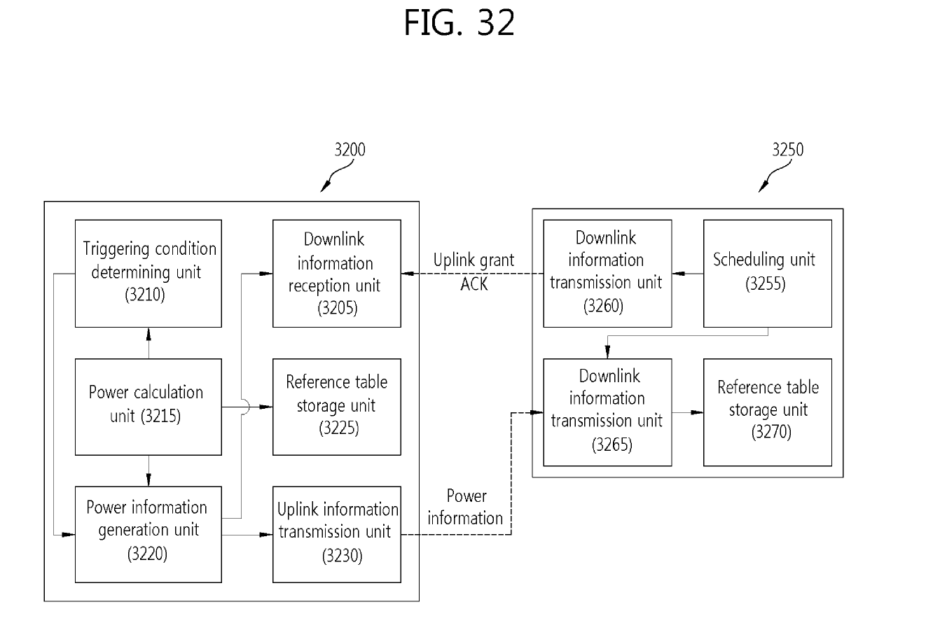

FIG. 32 is a block diagram showing a UE transmitting power information and a BS receiving power information according to an embodiment of the present invention.

With reference to FIG. 32, a UE 3200 includes a downlink information reception unit 3205, a triggering condition determining unit 3210, a power calculation unit 3215, a power information generation unit 3220, a reference table storage unit 3225, and an uplink information transmission unit 3230.

The downlink information reception unit 3205 receives an uplink grant from a BS 3250. Table 9 shows an example of the uplink grant. Also, the downlink information reception unit 3205 receives ACK indicating that the carrier maximum transmit power information has been successfully received, from the BS 3250.

The triggering condition determining unit 3210 determines whether or not a triggering condition is met. The triggering condition includes a first triggering condition and a second triggering condition. The first triggering condition is a triggering condition under which PH is reported, and the second triggering condition is a triggering condition under which carrier maximum transmit power is reported. In particular, the second triggering condition is that a CC, whose variation (ΔP_{cmax,c}), i.e., the difference between power amount determined in the reference table and a current carrier maximum transmit power amount, is greater than a threshold value, exists. In order to apply the second triggering condition, first, each CC must satisfy the first triggering condition. Namely, each CC should be selected as a target of reporting PH.

The power calculation unit 3215 calculates PH and carrier maximum transmit power of each CC. Each CC may be set in the UE 3200. Or, each CC may be set in the UE 3200 and activated. Or, each CC may be a UL PCC and/or a UL SCC. The power calculation unit 3215 informs the power information generation unit 3220 about the calculated PH and carrier maximum transmit power of each CC.

When the uplink grant is for a transmission of new data, the power information generation unit 3220 checks whether or not the PH information and carrier maximum transmit power information can be inserted in new data. When the PH information and carrier maximum transmit power information can be inserted, the power information generation unit 3220 generates power information including the PH information and carrier maximum transmit power information.

When the triggering condition is met, the reference table storage unit 3225 updates the reference table by reflecting the carrier maximum transmit power value in the reference table.

The uplink information transmission unit 3230 transmits the generated power information by using uplink resource indicated by the uplink grant.

The BS 3250 includes a scheduling unit 3255, a downlink information transmission unit 3260, an uplink information reception unit 3265, and a reference table storage unit 3270.

The scheduling unit 3255 performs uplink scheduling. The uplink scheduling refers to determining uplink resource required for the UE 3200 to perform an uplink transmission, and uplink parameters such as MCS, RV (redundancy version), or the like. An uplink grant is configured as A result of uplink scheduling.

The downlink information transmission unit 3260 transmits the uplink grant configured by the scheduling unit 3255, as a message to the UE 3200. Also, the downlink information transmission unit 3260 may transmit ACK indicating that carrier maximum transmit power information has been successfully detected from power information received from the UE 3200, to the UE 3200.

The uplink information reception unit 3265 receives power information from the UE 3200.

The reference table storage unit 3270 learns (recognizes or obtains) a carrier maximum transmit power value of each CC from the power information, and reflects the carrier maximum transmit power values in the existing reference table, thus updating the reference table.

The preferred embodiments of the present invention have been described with reference to the accompanying drawings, and it will be apparent to those skilled in the art that various modifications and variations can be made in the present invention without departing from the scope of the invention. Thus, the technical idea of the present invention should be interpreted to embrace all such alterations, modifications, and variations in addition to the accompanying drawings.

What is claimed is:

1. A method for transmitting power information regarding a component carrier by a user equipment (UE) in a multi-component carrier system, the method comprising:
calculating power headroom which can be additionally output with respect to an activated uplink component carrier;
calculating maximum transmit power configured for the activated uplink component carrier;
generating a medium access control (MAC) message including a first field indicating the power headroom and a second field indicating the maximum transmit power; and
transmitting the MAC message to a base station (BS),
wherein the MAC message includes a MAC subheader and a MAC control element, the MAC subheader includes a logical channel identifier (LCID) indicating that the MAC control element includes both the first and second fields, the MAC control element includes first and second octets each having an 8-bit length, and the first octet includes the first field and the second octet includes the second field.

2. The method of claim 1, wherein the MAC control element further includes a third octet, and the third octet includes a serving cell indicator field, and the serving cell indicator field indicates whether or not power headroom regarding each activated uplink component carrier is reported.

3. The method of claim 3, wherein the each of uplink component carriers configured in the UE corresponds to a bit of the serving cell indicator field, wherein the position of the bit is dedicatedly mapped to the each of the uplink component carriers.

4. The method of claim 1, wherein the second octet further includes at least one reserved field.

5. The method of claim 1, further comprising:
receiving an uplink grant indicating uplink resource for the MAC message from the BS,
wherein the MAC message is transmitted on the uplink resource.

6. The method of claim 5, wherein the uplink grant includes a new data indicator, and the new data indicator indicates that the uplink is for transmitting new uplink data.

7. The method of claim 1, further comprising:
triggering reporting of the power headroom,
wherein the transmission of the MAC message is initiated by the triggering.

8. The method of claim 1, further comprising:
updating a reference table storing a maximum transmit power value regarding every activated uplink component carrier configured in the UE.

9. A method for receiving power information regarding a component carrier by a base station in a multi-component carrier system, the method comprising:
transmitting an uplink grant indicating uplink resource required for an uplink transmission to a user equipment (UE); and
receiving a medium access control (MAC) message from the UE through the uplink resource,
wherein the MAC message includes a MAC control element and a MAC subheader, the MAC control element includes a first field, a second field, a first octet and a second octet, the MAC subheader includes a logical channel identifier (LCID) indicating that the MAC control element includes both the first and second fields,
and wherein the first field indicates power headroom which can be additionally output with regards to an activated uplink component carrier configured in the UE, the second field indicates maximum transmit power configured for the activated uplink component carrier, each of the first and second octets has an 8-bit length, the first octet includes the first field and the second octet includes the second field.

10. The method of claim 9, wherein the MAC control element further includes a third octet, and the third octet includes a serving cell indicator field, and the serving cell indicator field indicates whether or not power headroom regarding each activated uplink component carrier is reported.

11. The method of claim 10, wherein the each of uplink component carriers configured in the UE corresponds to a bit of the serving cell indicator field, wherein the position of the bit is dedicatedly mapped to the each of the uplink component carriers.

12. The method of claim 9, wherein the second octet further includes at least one reserved field.

13. The method of claim 9, wherein the uplink grant includes a new data indicator, and the new data indicator indicates that the uplink grant is for transmission of a new uplink data.

14. The method of claim 9, wherein the transmission of the MAC message is initiated by triggering reporting of the power headroom.

15. A user equipment (UE) for transmitting power information regarding a component carrier in a multi-component carrier system, the UE comprising:
a downlink information transmission unit for receiving an uplink grant for a transmission of new uplink data from a base station (BS);
a power calculation unit for calculating power headroom which can be additionally output by the UE with respect to an activated uplink component carrier and maximum transmit power configured for the activated uplink component carrier;
a power information generation unit for generating a medium access control (MAC) message including a first field indicating the power headroom and a second field indicating the maximum transmit power; and
an uplink information transmission unit for transmitting the MAC message to the BS,
wherein the MAC message includes a MAC subheader and a MAC control element, the MAC subheader includes a logical channel identifier (LCID) indicating that the MAC control element includes both the first and second fields, the MAC control element includes first and second octets each having an 8-bit length, and the first octet includes the first field and the second octet includes the second field.

16. The UE of claim 15, wherein the downlink information reception unit receives acknowledgement (ACK) indicating that the BS has successfully received the MAC message, from the BS.

17. A base station (BS) for receiving power information regarding a component carrier in a multi-component carrier system, the BS comprising:
a scheduling unit for determining an uplink parameter required for a user equipment (UE) to perform an uplink transmission and configuring an uplink grant with the determined uplink parameter;
an uplink information reception unit for receiving a medium access control (MAC) message including a first field indicating power headroom which can be additionally output by the UE with respect to an activated uplink component carrier and a second field indicating maximum transmit power configured for the activated uplink component carrier; and
a downlink information transmission unit for transmitting, to the UE, an acknowledgement (ACK) indicating that the MAC message has been successfully received and the uplink grant,
wherein the MAC message includes a MAC subheader and a MAC control element, the MAC subheader includes a logical channel identifier (LCID) indicating that the MAC control element includes both the first and second fields, the MAC control element includes first and second octets each having an 8-bit length, and the first octet includes the first field and the second octet includes the second field.
